(19) United States
(12) Patent Application Publication
(10) Pub. No.: US 2026/0127452 A1
(43) Pub. Date: May 7, 2026

(54) TECHNIQUES TO PREDICT COMPATIBILITY, APPLICABILITY, AND GENERALIZATION PERFORMANCE OF A MACHINE-LEARNING MODEL AT RUN TIME

(71) Applicant: The Regents of the University of California, Oakland, CA (US)

(72) Inventors: Abhejit Rajagopal, San Francisco, CA (US); Thomas A. Hope, San Francisco, CA (US); Peder E.Z. Larson, Oakland, CA (US)

(21) Appl. No.: 19/118,722

(22) PCT Filed: Oct. 5, 2023
(86) PCT No.: PCT/US2023/076062

§ 371 Date: Apr. 4, 2025

Related U.S. Application Data
(60) Provisional application No. 63/414,045, filed on Oct. 7, 2022.

(51) Int. Cl. G06N 5/022

(52) U.S. Cl. CPC G06N 5/022

(57) ABSTRACT

The present disclosure relates to analysis techniques to determine at run time whether a machine-learning model is applicable to a new set of input data. Particularly, aspects are directed to inputting an input query into a machine-learning model, generating, using the machine-learning model comprising model parameters learned for a particular task, a prediction associated with the task based on the input query, obtaining one or more metrics for generalization of the machine-learning model on the input query, the one or more metrics being computed using black-box and/or clear-box techniques for predicting a correctness of a model on a sample-by-sample basis (additionally applicable on a population level), by analyzing how the machine-learning model responds to the input query, and outputting a prediction of model generalization for the machine-learning model based on the one or more metrics.

### CROSS-REFERENCES TO RELATED APPLICATIONS

The present application claims benefit and priority to U.S. Provisional Application No. 63/414,045, filed on Oct. 7, 2022, the entire contents of which are incorporated herein by reference for all purposes.

### STATEMENT OF GOVERNMENT SUPPORT

The invention was made with government support under F32EB030411 awarded by the National Institute of Health and National Institute of Biomedical Imaging and Bioengineering; and under R01CA229354 awarded by the National Institute of Health and National Cancer Institute. The government has certain rights in the invention.

### FIELD

The present disclosure relates to machine-learning model generalization (i.e., inference success), and in particular to analysis techniques to determine at run time (i.e., the inference phase) whether a machine-learning model, such as a deep neural network (DNN) or a convolutional neural network (CNN), is applicable to (or will work correctly on) a new set of input data.

### BACKGROUND

A central goal of machine-learning is to have a predictive model generalize to previously-unseen data. In this respect, deep learning has enjoyed exceptional success on a wide variety of inference tasks (recognition, interpolation, extrapolation) and data types (images, video, text, graphs), using both supervised and unsupervised (or self-supervised) training. Yet, despite numerous attempts from statistical learning and approximation theorists, the secret to model generalization is still not well understood. Understanding the key properties of model generalization, even from an empirical standpoint, is especially important as deep learning makes its debut in critical human facing applications, such as transportation, medical imaging, and computer-aided diagnosis, where human-in-the-loop operation is not always possible or the goal is to exceed human capabilities.

In the context of image recognition tasks, the generalization performance of a predictive model is typically evaluated using p-norms on a set of previously-unseen images, colloquially called the test set. Although annotated datasets such as CIFAR. STL, and SVNH have relatively large test sets, there have been numerous examples where models with strong performance on these sets fail to generalize to similarly sampled data. This is classically understandable, as it is often intractable to obtain sufficient statistics on high-dimensional input domains (e.g. leading to an abundance of both natural and orchestrated adversarial attacks in the vicinity of the data), but this does not help to explain the uncanny generalization performance of deep networks on particular sets of previously-unseen data.

Moreover, statistical characterizations of performance (e.g., test-set “accuracy”) are not sufficient for building trust in model predictions, especially when the model inputs or features are not easily interpretable or verifiable by a user. Unlike low-dimensional models or models based on physics, conventional deep neural networks are unable to identify when they have made a mistake. This deficiency can again be traced to the high-dimensional nature of modem data-defined tasks like image recognition, where training data is typically so sparse that it is impossible to know when or where there is support for an inference using classical distance functions (e.g., mesh norm) without being overly pessimistic. This is problematic as most existing statistical and function approximation frameworks only apply in the vicinity or in the limit of data, or equivalent assumptions on the target function.

### SUMMARY

Analysis techniques are disclosed herein to determine at run time whether a machine-learning model is applicable to a new set of input data. The techniques are focused around analyzing the interior nodes of a machine-learning model (e.g., DNN) using a combination of algorithm parameters (e.g., DNN weights), historical data with annotations (e.g. training data), and historical and run-time data without annotations. Feedback obtained from the analysis can be provided to a user (e.g., clinician, operator) concerning whether the machine-learning model worked, whether it can be trusted, why it worked or did not work, and why it can or cannot be trusted. The techniques are applicable to any machine-learning system that accepts input data. Since the purpose of the techniques is to identify prediction success and failures at run time without human supervision, it is envisioned that such techniques could be the integrated into the field of machine-learning systems, particularly in applications where human supervision is either undesirable or infeasible. Specific examples within radiology include not only computer-aided diagnosis or classification, but also machine-learning based image reconstruction. There is also the application in many other industries, such as for self-driving cars, or any automated analysis or AI-assisted prediction software, such as for person identification from photos, or fraud analysis.

In various embodiments, a computer-implemented method is provided comprising: obtaining testing data without ground truth labels; inputting the testing data into a machine-learning model; generating, using the machine-learning model comprising model parameters learned for a particular task, a prediction associated with the task based on the test data; obtaining one or more metrics for generalization of the machine-learning model on the test data, where the obtaining comprises: (i) computing metrics using intermediate feature representations extracted from the nodes of the computational graph or abstract syntax tree (AST) of the machine learning model, (ii) computing metrics using the output prediction in conjunction with the input data or intermediate features, (iii) computing metrics using the model weights and architectures and its interactions with the input data, intermediate features, or output predictions, or (iv) any combination of (i-iii); and outputting a prediction of model generalization for the machine learning model at the population-level based on the one or more metrics.

In various embodiments, a computer-implemented method is provided comprising: obtaining testing data without ground truth labels; inputting the testing data into a machine-learning model; generating, using the machine-learning model comprising model parameters learned for a particular task, a prediction associated with the task based on the test data; obtaining one or more metrics for generalization of the machine-learning model on the test data, wherein the obtaining comprises of various neural trace analysis algorithms that capture, summarize, or derive intelligence from the intermediate feature representations at the nodes of the machine-learning model's computational graph or abstract syntax tree (AST) during program execution in response to input data; including but not limited to: (i) computing a clustering metric based on clustering of intermediate feature representations within input samples of the testing data, wherein the clustering is calculated based on a subset of samples obtained from training data with ground truth labels; (ii) computing a modified Mixup metric based on convex combinations of each of the input samples from the testing data and a subset of samples obtained from the training data with ground truth labels corresponding to the prediction for each of the input samples; (iii) computing a confidence metric based on clustering of the intermediate feature representations within the input samples of the testing data, wherein the clustering is calculated based on the input samples from the testing data; (iv) computing a roughness metric using dimensionality-reduction of the intermediate features to define a smoothness criteria for the training data and the testing data; or (v) any combination of (i)-(iv); and outputting a prediction of model generalization for the machine learning model at a level of the testing data based on the one or more metrics.

In some embodiments, the computing the clustering metric comprises: extracting the intermediate feature representations for each input sample in the testing data; performing, using the subset of samples and principal component analysis, the dimensionality-reduction of the intermediate features to predetermined dimensions at each layer of the machine-learning model, wherein the ground truth labels of the training data indicate membership to one or more classes; computing the clustering for the testing data based on a partition of the subset of samples, wherein the membership is used as the partition to compute and average the clustering metric to measure the clustering over each layer of the machine-learning model; fitting mixture models or kernel density estimators to the intermediate feature representations corresponding to the samples from the subset of samples in the partition, wherein the fitting comprises computing a secondary partition at each layer on the input samples in the testing data based on the clustering computed for the testing data to obtain parameters for the mixture models; and computing the clustering metric based on the measure of the clustering over each layer of the machine-learning model and the mixture models.

In some embodiments, the modified Mixup metric comprises: computing an agreement in classification between each of the input samples from the testing data and the subset of the training data corresponding to the prediction for each of the input samples; when the agreement is indicative that the prediction is incorrect, the input sample is mixed with a subset of the input samples from the testing data that correspond to the incorrect prediction; and when the agreement is indicative that the prediction is correct, using the agreement as the modified Mixup metric.

In some embodiments, the computing the confidence metric comprises: extracting the intermediate feature representations for each input sample in the testing data; computing a partition of the subset of samples obtained from training data by k-means or similar clustering of an output domain of each layer of the machine-learning model, wherein the ground truth labels of the training data indicate membership to one or more classes; computing the clustering for the testing data based on a partition of the subset of samples, wherein the membership is used as the partition to compute and average the clustering metric to measure the clustering over each layer of the machine-learning model; fitting mixture models or kernel density estimators to the intermediate feature representations corresponding to the samples from the subset of samples in the partition, wherein the fitting comprises computing a secondary partition at each layer on the input samples in the testing data based on the clustering computed for the testing data to obtain parameters for the mixture models; and computing the confidence metric based on the measure of the clustering over each layer of the machine-learning model and the mixture models.

In some embodiments, the computing the roughness metric comprises: extracting the intermediate feature representations for each input sample in the testing data; computing a partition of the subset of samples obtained from training data by k-means or similar clustering of an output domain of each layer of the machine-learning model, wherein the ground truth labels of the training data indicate membership to one or more classes; computing the clustering for the testing data based on a partition of the subset of samples, wherein the membership is used as the partition to compute and average the clustering metric to measure the clustering over each layer of the machine-learning model; and computing the roughness metric based on the measure of the clustering over each layer of the machine-learning model.

In some embodiments, the computer-implemented method further comprises predicting the model generalization for the machine learning model at the level of the testing data based on the one or more metrics.

In various embodiments, a computer-implemented method is provided comprising: obtaining a sample query without ground truth labels; inputting the sample query into a machine-learning model; generating, using the machine-learning model comprising model parameters learned for a particular task, a prediction associated with the task based on the sample query; obtaining one or more metrics for generalization of the machine-learning model on the sample query, where the obtaining comprises: (i) computing metrics using intermediate feature representations extracted from the nodes of the computational graph or abstract syntax tree (AST) of the machine learning model, (ii) computing metrics using the output prediction in conjunction with the input data or intermediate features, (iii) computing metrics using the model weights and architectures and its interactions with the input data, intermediate features, or output predictions, or (iv) any combination of (i-iii); and outputting a prediction of model generalization for the machine learning model at a level of the sample query based on the one or more metrics.

In various embodiments, a computer-implemented method is provided comprising: obtaining a sample query without ground truth labels; inputting the sample query into a machine-learning model; generating, using the machine-learning model comprising model parameters learned for a particular task, a prediction associated with the task based on the sample query; obtaining one or more metrics for generalization of the machine-learning model on the sample query, wherein the obtaining comprises of various neural trace analysis algorithms that capture, summarize, or derive intelligence from the intermediate feature representations at the nodes of the machine-learning model's computational graph or abstract syntax tree (AST) during program execution in response to input data; including but not limited to: (i) computing a clustering metric based on clustering of intermediate feature representations within the sample query, wherein the clustering is calculated based on a subset of samples obtained from training data with ground truth labels; (ii) computing a modified Mixup metric based on convex combinations of the sample query and a subset of samples obtained from the training data with ground truth labels corresponding to the prediction for the sample query; (iii) computing a confidence metric based on clustering of the intermediate feature representations within the sample query; or (iv) any combination of (i)-(iii); and outputting a prediction of model generalization for the machine learning model at a level of the sample query based on the one or more metrics.

In some embodiments, the computing the clustering metric comprises: extracting the intermediate feature representations for the sample query; performing, using the subset of samples and principal component analysis, the dimensionality-reduction of the intermediate features to predetermined dimensions at each layer of the machine-learning model, wherein the outputs machine-learning model's prediction of the sample query data indicate membership to one or more classes; computing the clustering for the sample query based on a partition of the subset of samples, wherein the membership is used as the partition to compute and average the clustering metric to measure the clustering over each layer of the machine-learning model; fitting mixture models or kernel density estimators to the intermediate feature representations corresponding to the samples from the subset of samples in the partition, wherein the fitting comprises computing a secondary partition at each layer on the sample query based on the clustering computed for the sample query to obtain parameters for the mixture models; and computing the clustering metric based on the measure of the clustering over each layer of the machine-learning model and the mixture models.

In some embodiments, the modified Mixup metric comprises: computing an agreement in classification between the sample query and the subset of the training data corresponding to the prediction for the sample query; when the agreement is indicative that the prediction is incorrect, the sample query is mixed with a subset of the input samples from the training data that correspond to the incorrect prediction; and when the agreement is indicative that the prediction is correct, using the agreement as the modified Mixup metric.

In some embodiments, the computing the confidence metric comprises: extracting the intermediate feature representations for the sample query; computing a partition of the subset of samples obtained from training data by k-means or similar clustering of an output domain of each layer of the machine-learning model, computing the clustering for the sample query based on a partition of the subset of samples, wherein the membership is used as the partition to compute and average the clustering metric to measure the clustering over each layer of the machine-learning model; fitting mixture models or kernel density estimators to the intermediate feature representations corresponding to the samples from the subset of samples in the partition, wherein the fitting comprises computing a secondary partition at each layer on the sample query based on the clustering computed for the sample query to obtain parameters for the mixture models; and computing the confidence metric based on the measure of the clustering over each layer of the machine-learning model and the mixture models.

In some embodiments, the computer-implemented method further comprises predicting the model generalization for the machine learning model at the level of the sample query based on the one or more metrics.

In some embodiments, a system is provided that includes one or more data processors and a non-transitory computer readable storage medium containing instructions which, when executed on the one or more data processors, cause the one or more data processors to perform part or all of one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1 illustrates a summary of proposed black-box and clear-box techniques for predicting machine-learning model generalization on a sample-by-sample and population basis in accordance with various embodiments;

FIG. 2 shows accuracy of mixup_score on a subset of PGDL Task 1_v4 models as a function on N in accordance with various embodiments;

FIG. 3 shows relative patch-wise distances from a test image to the training set qualitatively reveals better object segmentation (PGDL task1 Model 219) in accordance with various embodiments;

FIG. 4 shows a computing environment for predicting generalization of a machine-learning model in accordance with various embodiments;

FIG. 5 shows a process for predicting generalization of machine-learning models without labels on a population or dataset level in accordance with various embodiments;

FIG. 6 shows a process for predicting generalization of machine-learning models without labels on a sample by sample level in accordance with various embodiments:

FIG. 7 shows correlation plots for different metrics with and without ground truth annotations in accordance with various embodiments. The metrics without labels generally have excellent agreement with metrics utilizing labels. The top row corresponds to task1 models and bottom row corresponds to task2 models from the PGDL dataset. Each dot corresponds to a single model from the respective datasets;

FIG. 8 shows correlation plots demonstrating the cross-model correlation of different population metrics for the remaining PGDL Tasks 4-9 (Tasks 1-2 are shown in FIG. 7) in accordance with various embodiments. Mixup without labels consistently performs the best. The correlation is mostly negative for clustering, since the DB cluster index score is higher for model's with poorly clustered features, corroborating that data density in the dimensionality-reduced feature space correlates with performance;

FIG. 9 shows precision-recall curves for detecting model failures using different metrics on testing data without labels in accordance with various embodiments. The metrics without labels generally have excellent agreement with metrics utilizing labels. Top row corresponds to task1 models and bottom row corresponds to task2 models from the PGDL dataset. Each line corresponds to a single model from the respective datasets;

FIG. 10 shows violin plots depicting the distribution of AUC, accuracy, and F1-scores for CNN models corresponding to each PGDL task/dataset in accordance with various embodiments; and

FIG. 11 shows violin plots depicting the distribution of AUC, accuracy, and F1-scores corresponding to PGDL Task 1_v4 and PGDL Task 9 models using PGD-adversarially-attacked CIFAR-10 test-data in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

### Overview

The present disclosure relates to machine-learning model generalization (i.e., inference success). More specifically, embodiments of the present disclosure provide analysis techniques to determine at run time (i.e., the inference phase) whether a machine-learning model, such as a deep neural network (DNN) or a convolutional neural network (CNN), is applicable to a new set of input data and will perform correctly as intended. It should be understood that the examples and embodiments regarding DNNs and CNNs, and the like are described herein for illustrative purposes only and alternative machine-learning models or systems are applicable to the various analysis techniques disclosed herein. Moreover, the use of any of the disclosed analysis techniques for medical purposes can be used as is or modified to analyze performance of machine-learning models for non-medical purposes (e.g., self-driving cars, object detection and identification such as facial recognition software, fraud analysis, and the like), and one or more of these analysis techniques may be combined with one or more other analysis techniques to predict the applicability and generalization performance of a machine-learning model at run time in accordance with aspects of the present disclosure. The result being that the analysis techniques disclosed herein ensure that machine-learning model can be trusted for use by both human and robotic operators.

Misclassifications by machine-learning models may be analyzed by conventional systems, often in the context of outlier or adversarial detection. For example, Out of Distribution (OOD) detection in DNN classifiers has been described with respect to a softmax score as an indicator of within-distribution “confidence”. There has also been numerous improvements to OOD detection using input perturbations, temperature scaling, task-specific training, and data resampling techniques. However, none of these OOD detection systems addressed the generalization gap observed between training and testing sets, which are presumably sampled from the same distribution.

This challenge has been investigated more recently by systems that seek to directly predict the generalization gap of a deep network via theoretically and empirically-motivated complexity measures, albeit at the population- or dataset-level (i.e. by estimating the test set accuracy using the training set). This in turn raised the question of how model generalization can be measured directly from training data, and in response, conventional systems were developed that use a modified complexity metric based on the ratio of the margin distribution measured at the output layer to a spectral complexity measure related to the network's Lipschitz constant, similar to normalizations and other metrics developed for other conventional analysis systems. These modified complexity metrics have been demonstrated, using large-scale evaluations comparing the predictive power of 40 metrics with 10,000+ CNN models, to significantly improve performance by normalizing margin-based metrics layer-wise.

Rigorously evaluating complexity measures requires training many neural networks, computing the complexity measures on them, and analyzing statistics that condition over all variations in hyperparameters. The NeuriPS 2020 Predicting Generalization in Deep Learning (PGDL) Competition and Dataset provides an open-source collection of pre-trained models that can be used for this evaluation. The PGDL dataset is comprised of 550 CNN models distributed over different image classification tasks. The CNN models include VGG-like, Network in Network and Fully convolutional models. The original PGDL task involved predicting a complexity measure for each model given only its training data, such that the models can ranked by their generalization performance. The winning solution of the PGDL competition utilized 2 main metrics: “clusterability” and “mixup”, although many other solutions also utilized similar measures. These measures are largely focused on evaluating model performance on the dataset-level or population-level, relying solely on the availability of training and testing labels, in addition to analysis of model weights and gradients. While appropriate for evaluating generalization in broad strokes, this approach necessitates many implicit assumptions about the distribution of training and testing data. Consequently, it is theorized that techniques that utilize testing data (even without its labels) may provide an avenue for evaluating such assumptions. Moreover, predicting model performance at the population-level does not address the issue of data applicability or compatibility when a machine learning model is applied to a new data sample.

To address these challenges and others, the analysis techniques of the present embodiments utilize enhanced metrics for predicting generalization of a machine-learning model at inference time without ground truth annotations, both at the population-level and at the sample-by-sample level. These analysis techniques extend beyond conventional approaches and are applicable to settings where it is of interest to evaluate the applicability of trained models to inference-only datasets with possibly significant dataset shift.

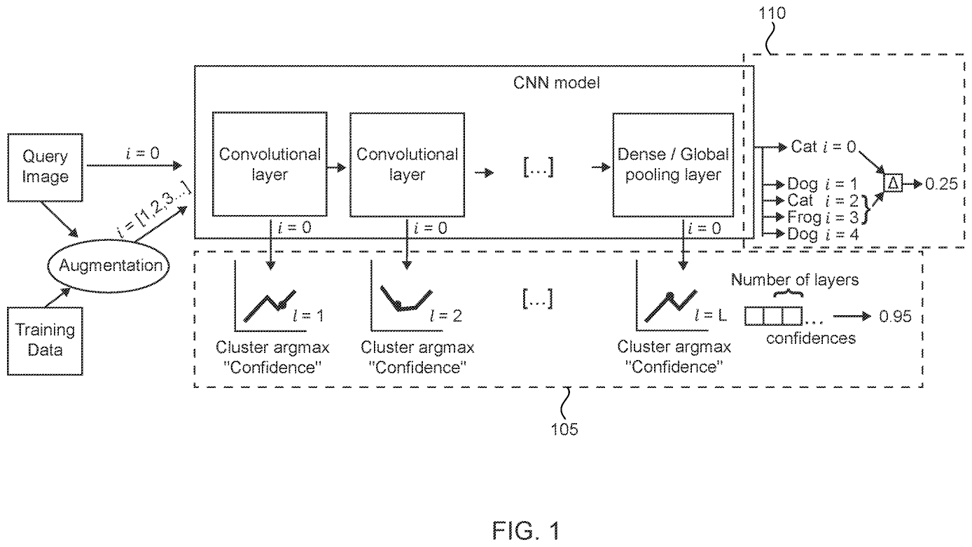

As shown in FIG. 1, the analysis techniques described in detail herein utilize black-box and clear-box techniques 105; 110 for predicting the “correctness” of a model on a sample-by-sample basis (additionally applicable on a population level), by analyzing how a network responds to an input query. The clear-box analysis technique 105 is based on approximation theory that attributes the performance of deep networks to compositional representations, and empirical work that demonstrates corresponding data concentrations at their low-dimensional nodes. The black-box technique 110 is based on learning principles such as Mixup, which has been demonstrated to be a good measure of generalization performance on population level. These enhanced metrics differ from supervised and Bayesian approaches that produce an uncertainty estimate by relying on aspects of the model architecture or training routine (e.g., dropout). Consequently, the analysis techniques of the present embodiments provide a number of improvements over existing technologies including analysis of the interior nodes and structure of a machine-learning model using theoretical techniques from approximation theory, utilization of both historical annotated data and unannotated data, providing a prediction of “correctness” on a sample-by-sample basis, and providing user friendly a visualization and numeric as an explanation of the prediction. The performance of these analysis techniques was compared with the conventional standard softmax techniques using the open-source dataset provided by the 2020 NeuriPS competition on PGDL, demonstrating that analysis of interior neural network layers yields comparable performance in detection of incorrectly classified samples.

One illustrative embodiment of the present disclosure is directed to a computer-implemented method for predicting generalization of machine-learning models without labels on a population or dataset level. The computer-implemented method includes: obtaining testing data without ground truth labels; inputting the testing data into a machine-learning model; generating, using the machine-learning model comprising model parameters learned for a particular task, a prediction associated with the task based on the test data; obtaining one or more metrics for generalization of the machine-learning model on the test data, where the obtaining comprises: (i) computing metrics using intermediate feature representations extracted from the nodes of the computational graph or abstract syntax tree (AST) of the machine learning model, (ii) computing metrics using the output prediction in conjunction with the input data or intermediate features, (iii) computing metrics using the model weights and architectures and its interactions with the input data, intermediate features, or output predictions, or (iv) any combination of (i-iii); and outputting a prediction of model generalization for the machine learning model at the population-level based on the one or more metrics.

In certain embodiments, the computer-implemented method includes: obtaining testing data without ground truth labels; inputting the testing data into a machine-learning model; generating, using the machine-learning model comprising model parameters learned for a particular task, a prediction associated with the task based on the test data; obtaining one or more metrics for generalization of the machine-learning model on the test data, where the obtaining comprises: (i) computing a clustering metric based on clustering of intermediate feature representations within input samples of the testing data, where the clustering is calculated based on a subset of samples obtained from training data with ground truth labels; (ii) computing a modified Mixup metric based on convex combinations of each of the input samples from the testing data and a subset of samples obtained from the training data with ground truth labels corresponding to the prediction for each of the input samples; (iii) computing a confidence metric based on clustering of the intermediate feature representations within the input samples of the testing data, where the clustering is calculated based on the input samples from the testing data; (iv) computing a roughness metric using dimensionality-reduction of the intermediate features to define a smoothness criteria for the training data and the testing data; or (v) any combination of (i)-(iv); and outputting a prediction of model generalization for the machine learning model at the population-level based on the one or more metrics.

Another illustrative embodiment of the present disclosure is directed to a computer-implemented method for predicting generalization of machine-learning models without labels on a sample-by-sample level. The computer-implemented method includes: obtaining a sample query without ground truth labels; inputting the sample query into a machine-learning model; generating, using the machine-learning model comprising model parameters learned for a particular task, a prediction associated with the task based on the sample query; obtaining one or more metrics for generalization of the machine-learning model on the sample query, where the obtaining comprises: (i) computing metrics using intermediate feature representations extracted from the nodes of the computational graph or abstract syntax tree (AST) of the machine learning model, (ii) computing metrics using the output prediction in conjunction with the input data or intermediate features, (iii) computing metrics using the model weights and architectures and its interactions with the input data, intermediate features, or output predictions, or (iv) any combination of (i-iii); and outputting a prediction of model generalization for the machine learning model at a level of the sample query based on the one or more metrics.

In certain embodiments, the computer-implemented method includes: obtaining a sample query without ground truth labels; inputting the sample query into a machine-learning model; generating, using the machine-learning model comprising model parameters learned for a particular task, a prediction associated with the task based on the sample query; obtaining one or more metrics for generalization of the machine-learning model on the sample query, where the obtaining comprises: (i) computing a clustering metric based on clustering of intermediate feature representations within the sample query, where the clustering is calculated based on a subset of samples obtained from training data with ground truth labels; (ii) computing a modified Mixup metric based on convex combinations of the sample query and a subset of samples obtained from the training data with ground truth labels corresponding to the prediction for the sample query; (iii) computing a confidence metric based on clustering of the intermediate feature representations within the sample query; or (iv) any combination of (i)-(iii); and outputting a prediction of model generalization for the machine learning model at a level of the sample query based on the one or more metrics.

Advantageously, these analysis techniques address the need to build trust in existing machine-learning models by accurately predicting and providing feedback to users (e.g., clinicians) about the validity of the input data with the machine-learning models, whether or not the machine-learning models will work, and whether or not the machine-learning models can be trusted. Further, the analysis techniques can be applied to any neural network or machine-learning model, whether for classification, regression, or like tasks. The analysis techniques and advantages thereof are expected to improve adoption of machine-learning model and also shorten the path to regulatory approval of new machine-learning based systems and tools.

### Definitions

As used herein, when an action is “based on” something, this means the action is based at least in part on at least a part of the something.

As used herein, the terms “substantially,” “approximately” and “about” are defined as being largely but not necessarily wholly what is specified (and include wholly what is specified) as understood by one of ordinary skill in the art. In any disclosed embodiment, the term “substantially,” “approximately,” or “about” may be substituted with “within [a percentage] of” what is specified, where the percentage includes 0.1, 1, 5, and 10 percent.

As used herein, “deep-learning” refers to a class of machine-learning algorithms that uses multiple layers to progressively extract higher-level features from the raw input. For example, in image processing, lower layers may identify edges, while higher layers may identify the features relevant to an object or subject such as digits or letters or surface texture or body parts.

As used herein, “neural trace” of a model or network or machine-learning algorithm refers to the intermediate feature representations extracted at the nodes of its computational graph or abstract syntax tree (AST) during program execution in response to input data.

As used herein, “neural trace analysis” refers to the process of generating and processing the neural trace of a machine learning algorithm.

### Metrics for Model Generalization at the Population or Dataset Level

In various embodiments, analysis techniques are disclosed for predicting model generalization on a population or dataset level based on test data without ground truth annotations or labels. In this context, it is assumed that a representative sampling of training data and their labels is available, for which classification performance is already confirmed to be sufficiently high, and examples from a test set are available for predicting model generalization. The success of the analysis techniques may be measured via controlled ranking correlation, conditional mutual information, or Pearson correlation coefficient across all models for a given recognition task using metrics derived from each model's neural trace.

### Clustering

Deep learning networks are capable of extracting semantic information useful for classification, however, it remains an open question as to how or why these representations offer an improvement over kernel, template-based, and dictionary learning approaches. For example, empirical approaches such as GradCAM have shown semantic information is typically only available in the last convolutional layer of a CNN. Moreover, deep networks with compositional representations have been demonstrated as being capable of avoiding the curse of dimensionality with respect to the degree of approximation (the number of terms or neurons), but until recently it was unclear if this was sufficient to achieve generalization in the context of sparse data-defined tasks. It has also been demonstrated that there exists compositional networks and target functions for which backpropagation yields data concentration on low dimensional interior nodes, although the networks considered were composed of nodes with dim ≤9. Further and more recently, it has been demonstrated that principal component analysis (PCA) can be used to represent and even cluster high dimensional DNN nodes.

The insights gathered from the afore-mentioned approaches have been used to facilitate development of a metric for model generalization that depends on the cluster-ability of its internal feature representations. Specifically, for a L-layered sequential deep network f=f_{L}(f_{L-1}( . . . f₁)): Rⁿ—+R^{m}, the intermediate feature representations comprising the neural trace {xₗ=fₗ(xₗ₋₁)∀l∈L} are extracted for every input query x in a dataset X. We define the “neural trace” of a model or network or machine-learning algorithm as the intermediate feature representations extracted at the nodes of its computational graph or abstract syntax tree (AST) during program execution in response to input data. The extracted neural network trace may be subsequently projected to a lower dimensional space via a dimensionality-reduction technique such as PCA to dₗ dimensions at each layer, and a clustering may computed based on a partition P of these samples in either the original space or the dimensionally-reduced samples at each layer of the neural trace. For example, if Xₜᵣ⊂X is from the training data for which there are labels indicating membership to one of C classes, the class-membership can be used as the partition to compute and average a Davies-Bouldin index score to measure clusterability of the feature representations of the input data in each layer of the network. In one embodiment, this is implemented by computing a ratio of the average intra-cluster distortion (Equation 1) and inter-cluster distance (Equation 2) for clusters without the same class label (Equation 3), and summing over the C classes (Equation 4):

$${S}_{i} = {( \frac{1}{\vert {P}_{i} \vert} {\sum }_{x ∈ {P}_{i}} {‖ x - {μ}_{i} ‖}_{p}^{q} )}^{1 / q} \qquad ( 1 )$$

$${M}_{i , j} = {‖ {μ}_{i} - {μ}_{j} ‖}_{p} \qquad ( 2 )$$

$${D}_{i} = {max}_{{C}_{i} \neq {C}_{j}} \frac{{S}_{i} + {S}_{j}}{{M}_{i , j}} \qquad ( 3 )$$

$$davies\_bouldin ( {X}_{ℓ} , P , \overline{C} ) = \frac{1}{\vert P \vert} {\sum }_{i = 1}^{P} {D}_{i} \qquad ( 4 )$$

where [symbol] represents the intermediate features extracted at layer l of a model or their dimensionally-reduced counterparts, P represents a partitioning of the data points [symbol] into |P| number of groups, and C̅ represents the membership of each cluster to one of C classes. In this context, each of the clusters defined by the partitioning P has a cluster centroid μᵢ and corresponding intra-cluster distortion Sᵢ. The partitioning P can be computed in an unsupervised way by clustering algorithms such as k-means on all datapoints in [symbol] , or may be computed in a supervised fashion by clustering algorithms such as k-means on an initial partitioning of [symbol] by groundtruth class membership, resulting in a class labels Cᵢ∈C for every cluster Pᵢ. In various embodiment, the clustering defining P and each μᵢ and Cᵢ may be computed using either the training set [symbol] ⊂Xₜᵣ⊂X, or the validation set [symbol] ⊂Xᵥₐₗ⊂X, while Equation 4 may be computed using either the training set [symbol] ⊂Xₜᵣ⊂X or the validation set Xₗ⊂Xᵥₐₗ⊂X. Here M_{i,j} represents distance between the centroids, so Dᵢ represents a ratio comparing adjacent clusters Pᵢ and Pⱼ of differing class labels Cᵢ and Cⱼ. Finally, there are many possible variations to this formulation, such as via the weighted sum of Dᵢ, as well as through choice of p and q. This computation seeks to measure how clustered the feature representation at each layer of a model's neural trace with respect to the groundtruth annotation class labels. The annotation class labels can be extended to continuous regression models by defining a simple windowing of the output range into one of C bins or class values.

Further, the neural trace can be summarized efficiently in each layer by fitting Gaussian mixture models (GMMs) to the intermediate features of each subset in the partition P, defined either by the class labels or a semantic partitioning of the training data. In some embodiments, this is achieved by computing a mixture model composed of M components for each partition Pᵢ of the features [symbol] . That is, for each subset of the initial partitioning, a secondary partition can be computed using algorithms such as Expectation-Maximization, to obtain the parameter sets θ={(φₘ, μₘ, Σₘ)∀m∈M}:

$$p ( θ \vert {X}_{ℓ} ) = {\sum }_{m = 1}^{M} {\hat{ϕ}}_{m} N \qquad ( 4 )$$

where φₘ represents the mixture weight, μₘ represents each cluster center, and Σₘ represents each cluster's covariance matrix. Computing the mixture model for each class annotation label results in a compact, low-dimensional geometry-conforming representation of the network trace of Xₜᵣ, which can be used for further querying and analysis.

It is theorized that smaller distances between query points in Xᵥₐₗ and Xₜᵣ associated with the same class label is indicative of better-trained feature extraction networks, as this requires lower polynomial degree to approximate, leading to better generalization. One approach to evaluate this is to identify layer-wise class membership using a validation set Xᵥₐₗ, using Equation (5):

$$\hat{y} = \{ {max}_{c} ‖ {x}_{l} - k ‖ ∀ m ∈ M , ∀ c ∈ C ∀ l ∈ L \} \qquad ( 5 )$$

where M mixtures are assumed for each of C classes. The GMM representation is particularly useful when the convex-hulls defined by a class-partitioning overlap. Further, agreement between the final classification and the internal classification can serve as a predictor of model performance, using Equation (5):

$$cluster\_trace ( f , ( {x}_{tr} , {y}_{tr} , {x}_{val} ) = \frac{1}{L} {\sum }_{l = 1}^{L} {ye}_{} = f ( {x}_{tr} ) ∀ l ∈ L \qquad ( 5 )$$

### Mixup Without Labels

Mixup was originally proposed as a data augmentation strategy to train “smoother” networks. Smoothness here refers to the oscillation of the target function in the convex linear subspaces formed by the training samples which share the same ground truth labels. Smoothness is imposed in Mixup-based training by asking that convex combinations of inputs sampled from a label set result in faithful reproduction of the same label, i.e. f(λ₁x₁+λ₂x₂)=y₁=y₂. Results have shown that, by and large, networks trained with this strategy have better generalization compared to the traditional training with empirical risk minimization. Moreover, it has been demonstrated that, for networks not trained using Mixup, performance on the Mixup samples correlates with their generalization performance.

In various embodiments, the Mixup strategy is extended to label-free scenarios by instead performing Mixup using convex combinations of an input query image and training data corresponding to its predicted class (as opposed to its true class obtained from the ground truth label). That is, Mixup without labels can be computed using Equation (6):

$$mixup\_without \_labels ( f , {x}_{tr} , {y}_{tr} , {x}_{val} ) = {f}_{} ( {λ}_{1} {x}_{val} + {λ}_{2} {x}_{tr} ) = {y}_{tr} ∀ {y}_{tr} = f ( {x}_{val} ) \qquad ( 6 )$$

where f is a machine learning model, xₜᵣ∈Xₜᵣ represents training data, xᵥₐₗ∈Xᵥₐₗ represents validation data, and the corresponding labels yₜᵣ=y\hat{ }ᵥₐₗ. Intuitively, this metric computes the agreement in classification with and without mixup-based augmentation, assuming the predicted target class is correct. When the predicted target class is incorrect, the input image is mixed with images of the incorrect class, providing significant distortion to the image features and resulting predictions, as long as the balance of λ₂ is kept appropriately low. More concretely, this strategy evaluates whether the network is locally-Lipschitz around testing points. As the evaluation of this metric does not rely on the availability of test-set labels, many more images may be used to correctly capture the behavior of the network away from the training data. This is directly related to a model's generalization, since the lack of locally-Lipschitz behavior implies that the classifier may abruptly change its predictions in the vicinity of the training or testing samples. In such cases, the decision boundary tends to be pushed closer to high-density regions that appear to violate the cluster assumption.

### Confidence/Data Likelihood

One downside of conventional cluster assignment and mixup strategies is that it requires access to ground truth labels, particularly in the training set. While this is normally not an issue, in many applications it is useful to know the validity of or confidence in a sample even if its classification is not positive (e.g., a don't-care class). As this is difficult to do in high dimensions in the input domain, aspects of present disclosure evaluate this data likelihood instead using a sample's network trace. That is, the partition of Xₜᵣ is first computed instead by k-means clustering of the output domain of each layer [symbol] : [symbol] → [symbol] pulling these back to the layer's inputs domain, resulting in several GMMs, one for each of k groups. Then compute cₗ using Equation (7):

$${c}_{l} ← max \{ p ( {x}_{l}^{′} \vert {θ}_{l , mj , {k}_{i}} ) ∀ {m}_{j} ∈ M , {k}_{i} ∈ \} ∀ l ∈ L \qquad ( 7 )$$

where

$${x}_{l}^{′}$$

represents the feature representation of validation data at layer l, and θ represents the parameters of the mixture components of the GMMs trained on training data, so cₗ represents the confidence or data likelihood given the trained GMM components.

Intuitively, what should be seen is higher values for samples that are within-distribution, and lower-values for samples that are out-of-distribution, regardless of which cluster center they are closest to. However, in practice what is observed is that the L₂ distance between query points is rather high, even using their network trace. Regardless, averaging this metric over the entire validation or testing dataset yields a metric of generalization that does not depend on the availability of any ground truth annotations. Specifically, the confidence can be computed and aggregated at each layer using Equation (8):

$$confidence ( f , {X}_{tr} , {X}_{val} ) = \frac{1}{L} {\sum }_{l = 1}^{L} {w}_{l} {c}_{l} ∀ l ∈ L \qquad ( 8 )$$

where here cₗ represents the average likelihood of the validation data at layer l, and wₗ is a factor for weighting importance to each layer. As discussed previously, based on the arguments from GradCAM and similar methods, one might want to assign higher importance to confidence values of deeper layers than the initial layers. It was found that giving the layers exponentially increasing weights between 0 and 1 with 0 for the input layer and 1 for the final output layer gave the best results.

### Roughness

Without the need for labels, the low-dimensional “manifold” representation of a training dataset (i.e., network trace for each sample) can be used to define a smoothness criteria for training and testing samples. While it is possible to evaluate the Jacobian of the network at each of these points directly, it is prohibitively expensive in existing programing frameworks, including both Tensorflow and Pytorch. To this end, a simpler metric may be defined by using k-means clusters of the input and output domain of each layer. That is, utilizing the same training-data clustering (without labels) used in the above section for Confidence/Data Likelihood, Equation (9) can be used to compute roughness as follows:

$$roughness = davies\_bouldin ( {x}_{l} , {f}_{l - 1} ( {X}_{val} ( l - 1 ) ) , {f}_{l} ( {X}_{val} ( l ) ) \qquad ( 9 )$$

where xₗ represents the neural trace at layer [symbol] , [symbol] (Xᵥₐₗ( [symbol] −1)) represents the cluster corresponding to xₗ at layer [symbol] −1, and fₗ(Xᵥₐₗ( [symbol] )) represents the predicted cluster at layer [symbol] .

Intuitively, this measure captures the number of samples that exist at the boundary of two semantically-clustered groups, presumably at an inflection point for the network. Note that, here the gradient of the model is described with respect to its inputs, rather than its gradient with respect to its weights.

### Metrics for Model Generalization at the Sample Level

Although the aforementioned population metrics bridge the gap between DNN theory by measuring generalization via regularity and data sparsity, accumulating sufficient test data to fully characterize a high-dimensional deep algorithm is often intractable. In practice, what is more useful than a population-level performance characterization is a sample-level measure, i.e., predicting uncertainty in the model prediction's on a single sample at runtime. Although in many cases, 1-hot encodings such as the softmax value yield a valuable practical measure of confidence, it remains unclear in all but the simplest networks how this relates to the theory of DNNs and their generalization properties. For example, ReLU networks with single pixel output predictions do not share this property. To this end, in various embodiments the aforementioned label-free population metrics are extended to operate at the sample level.

### Mixup Without Labels

The strategy described in the Mixup section with reference to generalization at the population or dataset level may also be used to make predictions about the correctness of individual sample classifications made by a network. This is achieved by first observing the predicted label of the network on a given sample, and subsequently drawing N samples from a mini-batch which are also predicted as having the same label. As per the mixup strategy, convex combinations of the given sample are then taken with each of these samples, resulting in N new predictions. Each prediction is compared to the original predicted label, resulting in a simplified metric for classification accuracy. This Mixup metric is calculated using Equation (10):

$$mixup\_score ( f , {X}_{val} ) = \frac{1}{L} {{\sum }^{L}}_{l = 1} mixup\_without \_labels ( f , {X}_{tr}^{l} , {Y}_{tr} , {X}_{val}^{l} ) ∀ l ∈ L \qquad ( 10 )$$

where f represents a machine learning model,

$${X}_{tr}^{l}$$

presents the neural trace corresponding to the training data at layer l, Yₜᵣ represents the training labels, and

$${X}_{val}^{l}$$

represents the neural trace corresponding to the training data at layer l,

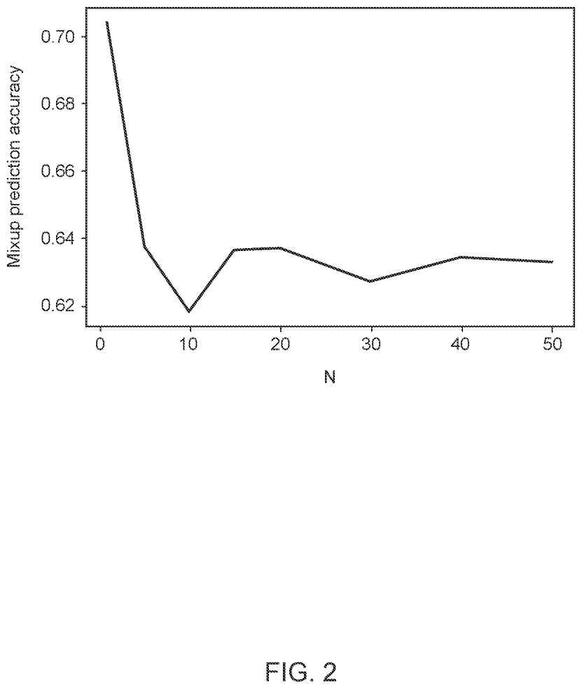

If the network shows “consistent” labels over N mixed-up classifications, the original class label is predicted as correct. Specifically, for each of these N predictions, a score of 1 is assigned if the prediction matches the original label and 0 otherwise. The mixup-score is defined as the mean of these N values. In order to make predictions about ambiguous samples, a threshold is defined to yield a classification. For the models in the 2020 PGDL dataset, there are very few if any misclassified training examples. As a result, in experiments using the various analysis techniques described herein a 5-fold striated cross validation was performed and 5% of test data was held out for each validation to determine the optimal threshold and the optimal threshold was then used to evaluate the remaining 95% test samples (as described further in Example section herein). One shortcoming of this strategy is that it requires access to a mini-batch to draw enough samples from, in order to generate sufficiently diverse Mixup samples. Nonetheless, as shown in FIG. 2, the evaluation of the metric for different values for N, demonstrates a tradeoff. For example, N=1 surprisingly has the best performance overall, but the performance stabilizes for greater values of N. To achieve robust performance, N=40 was chosen for the experiments using the various analysis techniques described herein, even though higher accuracy is possible and may be chosen on a model-by-model basis.

### Confidence/Data Likelihood

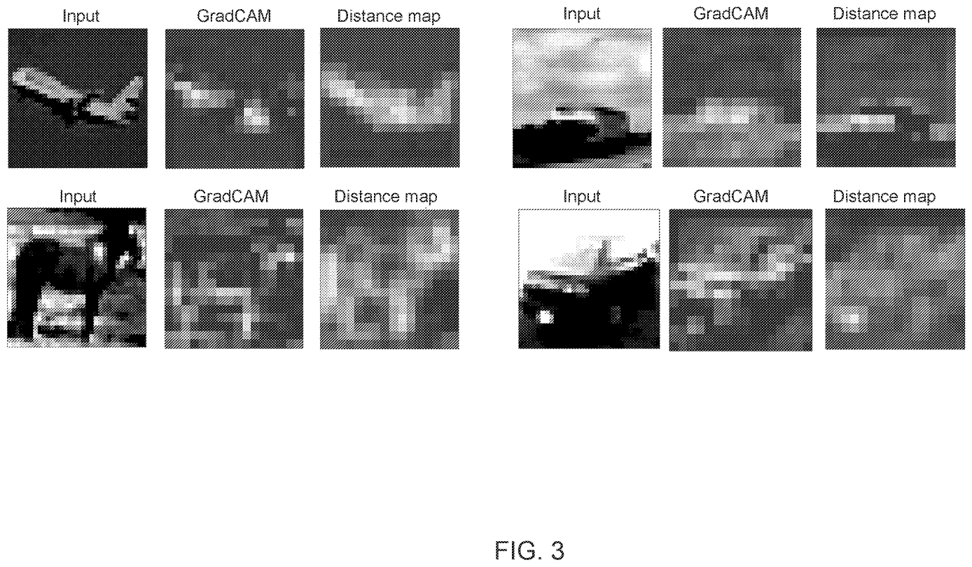

Due to the modular formulation observed in the Confidence/Data Likelihood section with reference to generalization at the population or dataset level, the confidence metric can be reused by limiting |Xᵥₐₗ|=1 in Equation (8) during evaluation. However, as mentioned, this metric does not appear to consistently correlate with the correctness of classification on a sample-by-sample basis in the current formulation. It is theorized that this is due to the observation that without special regularization typical CNNs violate manifold assumptions, or the embedding function is simply unknown. On the other hand, using a local-receptive field analysis technique, patch-wise distances may be found are surprisingly indicative of class-specific saliency. For example, in FIG. 3 the distance from each [3, 3] image patch to the training set Xₜᵣ was plotted, demonstrating qualitatively better object boundaries than Grad-CAM. However, as objects are of different sizes, thresholding and averaging this distance map may not yield a very useful metric on the sample level in the present form. However, interestingly image patches corresponding to target are actually further away from the training set than background patches, which is contrary to conventional notions of image similarity.

### Clustering Agreement of Query

In a similar fashion, the clustering metric described in the Clustering section with reference to generalization at the population or dataset level can be extended to the sample-basis by limiting |Xᵥₐₗ|=1 in Equation (5) during evaluation. Unlike the confidence score for sample level, the clustering metric does have excellent performance on the test set, although a slight amount of calibration is required similar to the operation of mixup without labels. However, re-weighting the scores of each layer by either the spectral norm of each layer's weights or by exponential decay starting from the final layer, was found to improves this metric.

### Systems for Predicting Generalization of Machine-Learning Models Without Labels

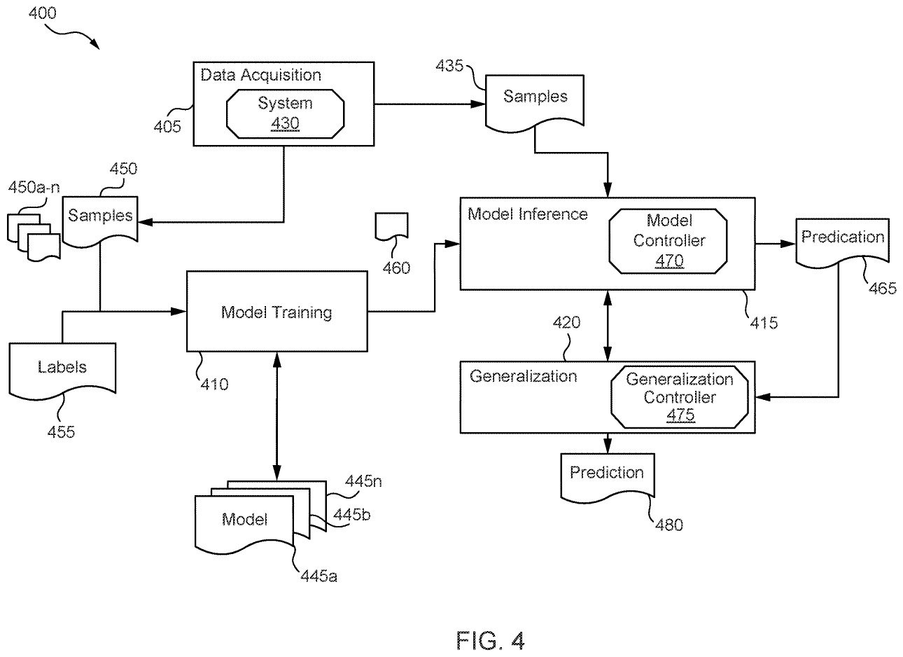

FIG. 4 illustrates an example computing environment 400 (i.e., a data processing system) for predicting generalization of a machine-learning model according to various embodiments. As shown in FIG. 4, the image reconstruction performed by the computing environment 400 in this example includes several stages: a data acquisition stage 405, a machine-learning model training stage 410, a machine-learning inference stage 415, and a generalization prediction stage 420.

The data acquisition stage 405 includes one or more systems 430 (e.g., an imaging system) for obtaining samples 435, 450 (e.g., images). The machine-learning model training stage 410 builds and trains one or more machine-learning models 445a-445n (‘n’ represents any natural number)(which may be referred to herein individually as a model 445 or collectively as the models 445) to be used by the other stages for predictions. The model 445 can be a machine-learning (“ML”) model, such as a convolutional neural network (“CNN”), e.g. an inception neural network, a residual neural network (“Resnet”), a U-Net, a V-Net, a single shot multibox detector (“SSD”) network, or a recurrent neural network (“RNN”), e.g., long short-term memory (“LSTM”) models or gated recurrent units (“GRUs”) models, or any combination thereof. The model 445 can also be any other suitable ML model trained in image reconstruction, such as a three-dimensional CNN (“3DCNN”), a dynamic time warping (“DTW”) technique, a hidden Markov model (“HMM”), etc., or combinations of one or more of such techniques—e.g., CNN-HMM or MCNN (Multi-Scale Convolutional Neural Network). The computing environment 400 may employ the same type of model or different types of models for predictions.

To train a model 445 in this example, samples 450 are generated, for example by acquiring digital images, splitting the samples into a subset of samples 450a for training (e.g., 90%) and a subset of samples 450b for validation (e.g., 10%), preprocessing the subset of samples 450a and the subset of samples 450b, optionally augmenting the subset of samples 450a, and in some instances annotating the subset of samples 450a with labels 455. In some instances, the subset of samples 450a are acquired from a data storage structure such as a database, a computing system (e.g., one or more systems 430), or the like associated with the one or more modalities. The splitting may be performed randomly (e.g., a 90/10% or 70/30%) or the splitting may be performed in accordance with a more complex validation technique such as K-Fold Cross-Validation. Leave-one-out Cross-Validation, Leave-one-group-out Cross-Validation, Nested Cross-Validation, or the like to minimize sampling bias and overfitting. The preprocessing may comprise cropping the samples such that each sample only contains a single object of potential interest. In some instances, the preprocessing may further comprise standardization or normalization to put all features on a same scale or dimension (e.g., a same size scale or a same color scale or color saturation scale). In certain instances, the samples are resized with a minimum size (width or height) of predetermined pixels (e.g., 2500 pixels) or with a maximum size (width or height) of predetermined pixels (e.g., 3000 pixels) and kept with the original aspect ratio.

Augmentation can be used to artificially expand the size of the subset of samples 450a by creating modified versions of samples in the datasets. Image data augmentation may be performed by creating transformed versions of images in the datasets that belong to the same class as the original image. Transforms include a range of operations from the field of image manipulation, such as shifts, flips, zooms, and the like. In some instances, the operations include random erasing, shifting, brightness, rotation, Gaussian blurring, and/or elastic transformation to ensure that the model 445 is able to perform under circumstances outside those available from the subset of samples 450a (generalization).

Annotation can be performed manually by one or more humans (annotators such as radiologists or pathologists) confirming characteristics of each sample of the subset of samples 450a and providing labels 455 to the samples. In some instances, a subset of samples 450 may be transmitted to an annotator device to be included within a training data set (i.e., the subset of samples 450a). Input may be provided (e.g., by a radiologist) to the annotator device using (for example) a mouse, track pad, stylus and/or keyboard that indicates (for example) the ground truth image, signal model, system matrix, and/or sensor measurements to be used for reconstructing the image. Annotator device may be configured to use the provided input to generate labels 455 for each sample. For example, the labels 455 may include the ground truth, a signal model, a system matrix, and/or assay measurements. For the samples, which are annotated by multiple annotators, the labels from all annotators may be used. In some instances, annotation data may further indicate a type of an object of potential interest. For example, if an object of potential interest is an organ, then annotation data may indicate a type of organ or tissue, such as a liver, a lung, a pancreas, and/or a kidney.

The training process for model 445 includes selecting hyperparameters for the model 445 and performing iterative operations of inputting samples from the subset of samples 450a into the model 440 to find a set of model parameters (e.g., weights and/or biases) that minimizes a cost function such as loss or error function for the model 445. The hyperparameters are settings that can be tuned or optimized to control the behavior of the model 445. Most models explicitly define hyperparameters that control different aspects of the models such as memory or cost of execution. However, additional hyperparameters may be defined to adapt a model to a specific scenario. For example, the hyperparameters may include the number of hidden units of a model, the learning rate of a model, the convolution kernel width, or the number of kernels for a model. The cost function can be constructed to measure the difference between the outputs inferred using the models 445 (the machine-learning prediction) and the ground truth annotated to the samples using the labels 455. For example, image data may be input through the model 445 and the prediction of presence of an object in the image may be compared to actual presence or absence of the object in the image as determined from the labels 455 (ground truth). The differences between the prediction and ground truth are used via backpropagation to modify the model parameters of the model 445 to train or strengthen the model 445 and obtain the desired output.

Once a set of model parameters are identified that obtain the desired output, the model 445 has been trained and can be validated using the subset of samples 450b (testing or validation data set). The validation process includes iterative operations of inputting samples from the subset of samples 450b into the model 445 using a validation technique such as K-Fold Cross-Validation, Leave-one-out Cross-Validation, Leave-one-group-out Cross-Validation, Nested Cross-Validation, or the like to tune the hyperparameters and ultimately find the optimal set of hyperparameters. Once the optimal set of hyperparameters are obtained, a reserved test set of samples from the subset of samples 450b are input into the model 445 to obtain output (the reconstructed image), and the output is evaluated versus ground truth images using correlation techniques such as Bland-Altman method and the Spearman's rank correlation coefficients and calculating performance metrics such as the error, accuracy, precision, recall, receiver operating characteristic curve (ROC), etc.

As should be understood, other training/validation mechanisms are contemplated and may be implemented within the computing environment 400. For example, the model 445 may be trained and hyperparameters may be tuned on samples from the subset of samples 450a and the samples from the subset of samples 450b may only be used for testing and evaluating performance of the model 445. Moreover, although the training mechanisms described herein focus on training a new model 445. These training mechanisms can also be utilized to fine tune existing models 445 trained from other datasets. For example, in some instances, a model 445 might have been pre-trained using samples from different modalities. In those cases, the models 445 can be used for transfer learning and retrained/validated using the samples 450.

The machine-learning model training stage 410 outputs trained models including one or more trained models 460 for use in machine-learning inference stage 415. A prediction 465 is obtained by a model controller 470 using the one or more trained models 460 within the machine-learning inference stage 415. For example, the model controller 470 executes processes for inputting samples 435 from system 430 into the one or more trained models 460, generating, using the one or more trained models 460, the prediction 465 (e.g., a predicted class of an object) based on features extracted from the samples 435, and obtaining the prediction 465 from the one or more trained models 460.

The samples 435; 450, one or more trained models 460, and the prediction 465 are availed to a generalization controller 475 within the generalization prediction stage 420. A prediction 480 of model generalization for the one or more trained models 460 is made by the generalization controller 475 on a sample-by-sample basis (additionally applicable on a population level), by analyzing how the one or more machine-learning models 460 respond to an input query. More specifically, an input query (e.g., sample 435) may be input into the one or more machine-learning models 460 comprising model parameters learned for a particular task, the one or more machine-learning models 460 may be used to generate a prediction 465 associated with the task based on the input query, the generalization controller 475 may compute one or more metrics for generalization of the one or more machine-learning models 460 on the input query (the one or more metrics being computed using black-box and/or clear-box techniques for predicting a correctness of a model by analyzing how the one or more machine-learning models responds to the input query), and the generalization controller 475 may output prediction 480 of model generalization for the one or more machine-learning models 460 based on the one or more metrics.

While not explicitly shown, it will be appreciated that the computing environment 400 may further include a developer device associated with a developer. Communications from a developer device to components of the computing environment 400 may indicate what types of input samples, measurement data, and/or images are to be used for the models, a number and type of models to be used, hyperparameters of each model, for example, learning rate and number of hidden layers, how data requests are to be formatted, which training data is to be used (e.g., and how to gain access to the training data) and which validation technique is to be used, and/or how the controller processes are to be configured.

### Techniques for Predicting Generalization of Machine-Learning Models Without Labels

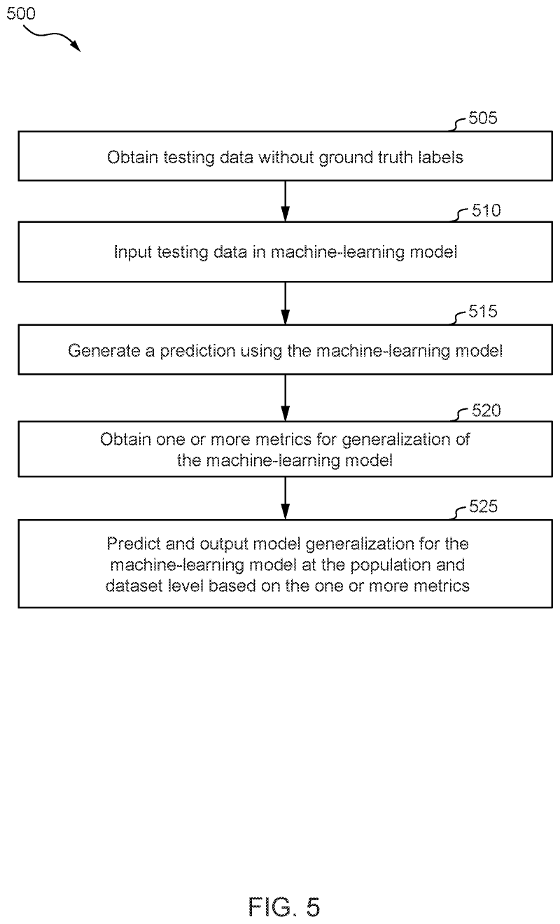

FIG. 5 is a flowchart illustrating a process 500 for predicting generalization of machine-learning models without labels on a population or dataset level according to various embodiments. The processing depicted in FIG. 5 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 5 and described below is intended to be illustrative and non-limiting. Although FIG. 5 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIG. 4, the processing depicted in FIG. 5 may be performed by one or more machine-learning models 460, model controller 470, and generalization controller 475 to generate predictions on generalization of a machine learning model.

Process 500 begins at block 505 where testing data is obtained without ground truth labels. At block 510, the testing data is input into a machine-learning model comprising model parameters learned for a particular task (e.g., object recognition). At block 515, a prediction (e.g., class of an object) is generated by the machine-learning model. The prediction is associated with the task and generated based on the test data.

At block 520, one or more metrics for generalization of the machine-learning model on the test data are obtained. The obtaining of one or more metrics comprises of various neural trace analysis algorithms that capture, summarize, or derive intelligence from the neural trace that is generated by input data interacting with the machine-learning model. Some examples of this include: (i) computing a clustering metric based on clustering of intermediate feature representations within input samples of the testing data, where the clustering is calculated based on a subset of samples obtained from training data with ground truth labels; (ii) computing a modified Mixup metric based on convex combinations of each of the input samples from the testing data and a subset of samples obtained from the training data with ground truth labels corresponding to the prediction for each of the input samples; (iii) computing a confidence metric based on clustering of the intermediate feature representations within the input samples of the testing data, where the clustering is calculated based on the input samples from the testing data; (iv) computing a roughness metric using dimensionality-reduction of the intermediate features to define a smoothness criteria for the training data and the testing data; or (v) any combination of (i)-(iv).

Computing the clustering metric comprises: (a) extracting the intermediate feature representations for each input sample in the testing data; (b) performing, using the subset of samples and principal component analysis, the dimensionality-reduction of the intermediate features to predetermined dimensions at each layer of the machine-learning model; (c) computing the clustering for the testing data based on a partition of the subset of samples (Equations (1) and (2)), where the ground truth labels of the training data indicate membership to one or more classes, and where the membership is used as the partition to compute and average the clustering metric to measure the clustering over each layer of the machine-learning model; (d) fitting mixture models or kernel density estimating models to the intermediate feature representations corresponding to the samples from the subset of samples in the partition (Equation (3)), where the fitting comprises computing a secondary partition at each layer on the input samples in the testing data based on the clustering computed for the testing data to obtain parameters for the mixture or density models; and (e) computing the clustering metric based on the measure of the clustering over each layer of the machine-learning model and the mixture or density models (Equation (5)).

Computing the modified Mixup metric comprises: (a) computing an agreement in classification between each of the input samples from the testing data and the subset of the training data corresponding to the prediction for each of the input samples (Equation (6)); (b) when the agreement is indicative that the prediction is incorrect, the input sample is mixed with a subset of the input samples from the testing data that correspond to the incorrect prediction; and (c) when the agreement is indicative that the prediction is correct, using the agreement as the modified Mixup metric.

Computing the confidence metric comprises: (a) extracting the intermediate feature representations for each input sample in the testing data; (b) computing a partition of the subset of samples obtained from training data by k-means or similar clustering of an output domain of each layer of the machine-learning model; (c) computing the clustering for the testing data based on a partition of the subset of samples, where the ground truth labels of the training data indicate membership to one or more classes, and where the membership is used as the partition to compute and average the clustering metric to measure the clustering over each layer of the machine-learning model; (d) fitting mixture models or kernel density estimating models to the intermediate feature representations corresponding to the samples from the subset of samples in the partition, where the fitting comprises computing a secondary partition at each layer on the input samples in the testing data based on the clustering computed for the testing data to obtain parameters for the mixture models (Equation (7)); and (e) computing the confidence metric based on the measure of average distance and overlap in each layer of the machine-learning model (Equation (8)).

Computing the roughness metric comprises: (a) extracting the intermediate feature representations for each input sample in the testing data; (b) computing a partition of the subset of samples obtained from training data by k-means clustering of an output domain of each layer of the machine-learning model; (c) computing the clustering for the testing data based on a partition of the subset of samples, where the ground truth labels of the training data indicate membership to one or more classes, and where the membership is used as the partition in each layer of the machine-learning model; and (d) computing the roughness metric based on clustering association across layers of the machine-learning model (Equation (9)).

At block 525, the model generalization for the machine learning model at the level of the testing data is predicted and output based on the one or more metrics. In some instances, the prediction is provided to a user, system, or device. For example, the prediction may be stored in a storage device, communicated to a user, communicated to a computing system, and/or displayed on a user device.

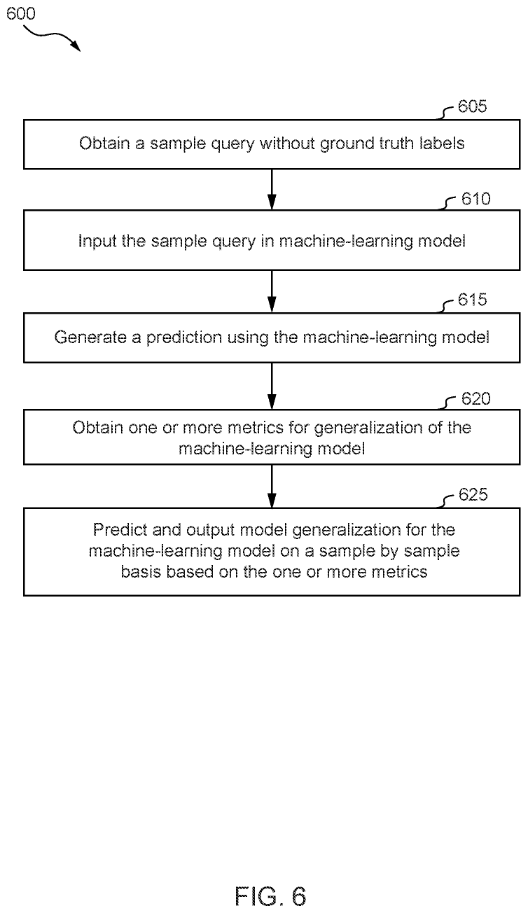

FIG. 6 is a flowchart illustrating a process 600 for predicting generalization of machine-learning models without labels on a sample-by-sample basis according to various embodiments. The processing depicted in FIG. 6 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 6 and described below is intended to be illustrative and non-limiting. Although FIG. 6 depicts the various processing steps occurring in a particular sequence or order, this is not intended to be limiting. In certain alternative embodiments, the steps may be performed in some different order or some steps may also be performed in parallel. In certain embodiments, such as in the embodiment depicted in FIG. 4, the processing depicted in FIG. 6 may be performed by one or more machine-learning models 460, model controller 470, and generalization controller 475 to generate predictions on generalization of a machine learning model.

Process 600 begins at block 605 where a sample query is obtained without ground truth labels. At block 610, the sample query is input into a machine-learning model comprising model parameters learned for a particular task (e.g., object recognition). At block 615, a prediction (e.g., class of an object) is generated by the machine-learning model. The prediction is associated with the task and generated based on the sample query.

At block 620, one or more metrics for generalization of the machine-learning model on the test data are obtained. The obtaining of one or more metrics comprises of various neural trace analysis algorithms that capture, summarize, or derive intelligence from the neural trace that is generated by input data interacting with the machine-learning model. Some examples of this include: (i) computing a clustering metric based on clustering of intermediate feature representations within the sample query, where the clustering is calculated based on a subset of samples obtained from training data with ground truth labels; (ii) computing a modified Mixup metric based on convex combinations of the sample query and a subset of samples obtained from the training data with ground truth labels corresponding to the prediction for the sample query; (iii) computing a confidence metric based on clustering of the intermediate feature representations within the sample query; (iv) computing a roughness metric using dimensionality-reduction of the intermediate features to define a smoothness criteria for the training data and the testing data; or (v) any combination of (i)-(iv).

Computing the clustering metric comprises: (a) extracting the intermediate feature representations for the sample query; (b) performing, using the subset of samples and previously learned principal component analysis, the dimensionality-reduction of the intermediate features to predetermined dimensions at each layer of the machine-learning model; (c) computing the clustering for the sample query based on a subset of its corresponding distribution of feature representations at each layer, where the output prediction indicates membership to one or more classes; (d) fitting mixture models or kernel density estimators to the intermediate feature representations corresponding to the samples from the subset of samples in the partition (Equation (3)), where the fitting comprises computing a secondary partition at each layer on the sample query based on the clustering computed for the sample query to obtain parameters for the mixture models; and (e) computing a clustering metric based on the measure of the clustering between the clusters defined by the sample query and clusters defined by the training data and their ground truth labels in each layer of the machine-learning model (Equation (5)—limiting |Xval|=1).

Computing the modified Mixup metric comprises: (a) computing an agreement in classification between the sample query and the subset of the training data corresponding to the prediction for the sample query (Equation (10)); (b) when the agreement is indicative that the prediction is incorrect, the sample query is mixed with a subset of the input samples from the training data that correspond to the incorrect prediction; and (c) when the agreement is indicative that the prediction is correct, using the agreement as the modified Mixup metric.

Computing the confidence metric comprises: (a) extracting the intermediate feature representations for the sample query; (b) computing a partition of the subset of samples obtained from training data by k-means or similar clustering of an output domain of each layer of the machine-learning model; (c) computing the clustering for the sample query based on a partition of the subset of samples, where the membership is used as the partition to compute and average the clustering metric to measure the clustering over each layer of the machine-learning model; (d) fitting mixture models or kernel density estimating models to the intermediate feature representations corresponding to the samples from the subset of samples in the partition, where the fitting comprises computing a secondary partition at each layer on the input samples in the testing data based on the clustering computed for the testing data to obtain parameters for the mixture models (Equation (7)); and (e) computing the sample-wise confidence metric based on the measure of distance and overlap in each layer of the machine-learning model (Equation (8)—limiting |Xval|=1).

At block 625, the model generalization for the machine learning model at the level of the sample query is predicted and output based on the one or more computed metrics. In some instances, the final output is computed based on a weighted average of a subset of the metrics computed for the sample query, in relation to the weighted of the metrics computed on prior training or validation data used to develop the machine-learning model on a particular inference task. In some instances, the prediction is provided to a user, system, or device. For example, the prediction may be stored in a storage device, communicated to a user, communicated to a computing system, and/or displayed on a user device. In some instances, the output can be used to determine whether the provided input was compatible or applicable to the machine-learning model, or to identify when the machine-learning model may produce a false or inaccurate prediction even if the provided input was compatible or applicable. The generalization output at block 625 can be used to identify whether a machine-learning model is ready to be deployed in a particular setting, to bring particular failure or success sample queries to the attention of a human or another computer process, or to provide a measure of accuracy in the prediction of the model for new test queries. For example, a machine-learning model with many outputs indicating poor generalization could inform practitioners that their machine-learning model is not ready for deployment, and to instead re-train their model using more diverse data, such as the sample queries that resulted in poor generalization predictions.

### EXAMPLES

The systems and methods implemented in various embodiments may be better understood by referring to the following examples.

### Experimental Setup

The following experimental setup was used:

Model Dataset: The open-source 2020 NeurIPS PGDL dataset (Apache 2.0 license) was used, which is comprised of 550 models over 9 different classification tasks, as well as starter code to evaluate the correlation between baseline metrics and generalization performance.

Image Dataset: The 2020 NeurIPS PGDL includes the following datasets: CIFAR10, SVNH, CINIC10, Oxford pets, Oxford Flowers, and Fashion MNIST.

Computational resources: One dual 20-core Xeon machine with 192 GB RAM, 2 GPUs, and 5 TB of storage, to run inference on all models in the PGDL dataset and extract their network traces.

Train/Validation/Test Split: For many of the metrics proposed, large samplings of training data were required to compute PCA and cluster the features at each layer. This was accomplished by selecting 1000 images randomly from each of the training datasets, and using the remaining data for validation and test, respectively. For the sample-level detection experiments, additional data was required due to the dearth of negative examples in the PGDL dataset. To this end, in the sample-level test-set experiments 5-fold striated cross validation was performed and 5% of test data was held out for each validation to determine the optimal threshold and that optimal threshold was used to evaluate the remaining 95% test samples. Each metric's performance was reported with and without the 5-fold cross validation to demonstrate consistency in the performance indicative of a robust measure.

PCA: For computing cluster_trace, PCA was used to reduce the dimensionality with 95% retained variance. For roughness, it was found that convolutional layers with very large dimensions, reducing the dimensionality below 250 resulted in slightly worse performance. For confidence metric however, since it is computed on feature patches of the receptive field, the dimensionality of original feature space is lower as compared to the full feature maps and this allowed reduction in the dimensionality to 3 PCA components. These values were chosen to trade-off between performance of the metric and computational time.

KMeans Clustering per class: used 3 components as number of clusters per class.

GMM clusters per class: to compute confidence metric, trained GMMs were trained with 3 mixture components per class.

Population-Level Correlation with and without Labels

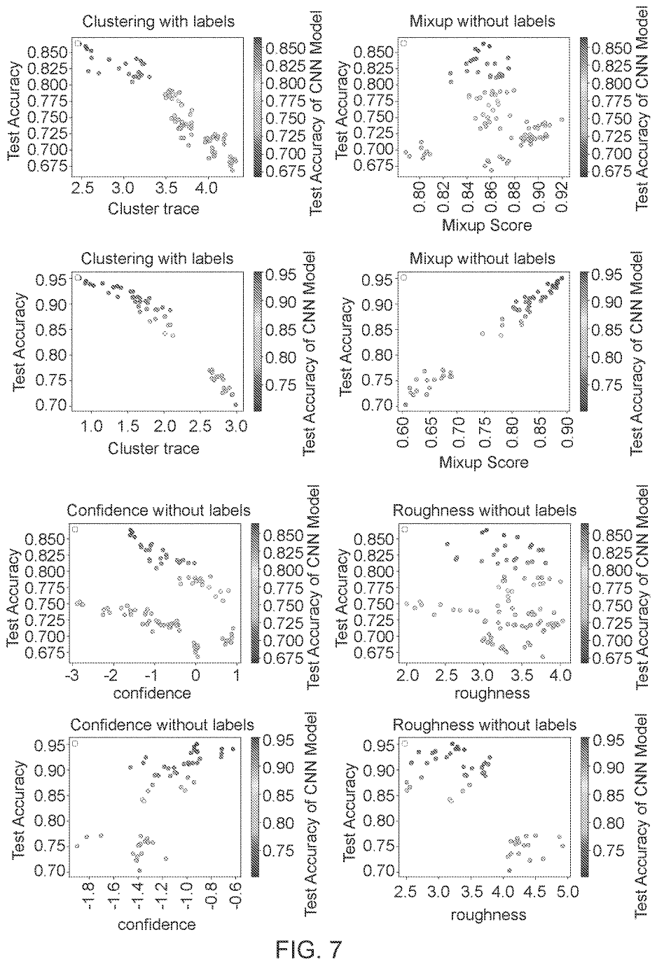

The Pearson correlation coefficient for different metrics was evaluated on training data with labels and testing data without labels. Numeric results on the Task/Population level are shown in Table 1 below, while a visual overview of some metrics are shown in FIG. 7. In short, clustering was demonstrated to have excellent correlation on both task1 v4 (CIFAR-10 classification) and task2_v1 (SVNH), but surprisingly poor correlation on the remaining tasks. In contrast, Mixup has excellent performance on all tasks except task1_v4, and excellent agreement between the scores with and without labels (except for task1_v4-test and task7-test). Although the confidence and roughness metrics do not have exceptional performance, there is excellent agreement between training and testing data indicating that the method is consistent. Visual analysis of model performance vs predicted metric indicates that correlation is sometimes underestimates the performance of a metric, e.g. where there appears to be multiple groups where a high linear correlation exists for each one separately.

TABLE 1
Performance on a population basis over all PGDL Tasks/Datasets. The value in each
cell represents the Pearson correlation coefficient between the model-wise (population-level)
metric and the reported test classification accuracy, using the indicated data set. Higher
magnitudes are better.

| | | | | | Mixup | | | | Roughness | |
|---|---|---|---|---|---|---|---|---|---|---|
| | Clustering | | Mixup (with | | (without | | Confidence | | (without | |
| | (with labels) | | labels) | | labels) | | (without labels) | | labels) | |
| Task | Train | Test | Train | Test | Train | Test | Train | Test | Train | Test |
| task1_v4 | −0.943 | −0.938 | 0.091 | 0.821 | 0.093 | −0.118 | −0.231 | −0.232 | −0.054 | −0.045 |
| task2_v1 | −0.945 | −0.965 | 0.988 | 0.990 | 0.988 | 0.986 | 0.733 | 0.723 | −0.756 | −0.764 |
| task4 | −0.003 | −0.284 | 0.923 | 0.938 | 0.923 | 0.887 | 0.137 | 0.143 | 0.544 | 0.561 |
| task5 | −0.183 | −0.267 | 0.909 | 0.970 | 0.909 | 0.967 | −0.301 | −0.294 | 0.412 | 0.355 |
| task6 | −0.465 | −0.431 | 0.968 | 0.944 | 0.967 | 0.952 | −0.742 | −0.742 | 0.832 | 0.843 |
| task7 | −0.635 | −0.689 | 0.654 | 0.864 | 0.658 | 0.434 | 0.411 | 0.344 | 0.422 | 0.400 |
| task8 | 0.144 | −0.148 | 0.794 | 0.813 | 0.792 | 0.808 | −0.778 | −0.778 | 0.686 | 0.694 |
| task9 | −0.598 | −0.635 | 0.929 | 0.944 | 0.934 | 0.883 | −0.288 | −0.298 | 0.422 | 0.445 |

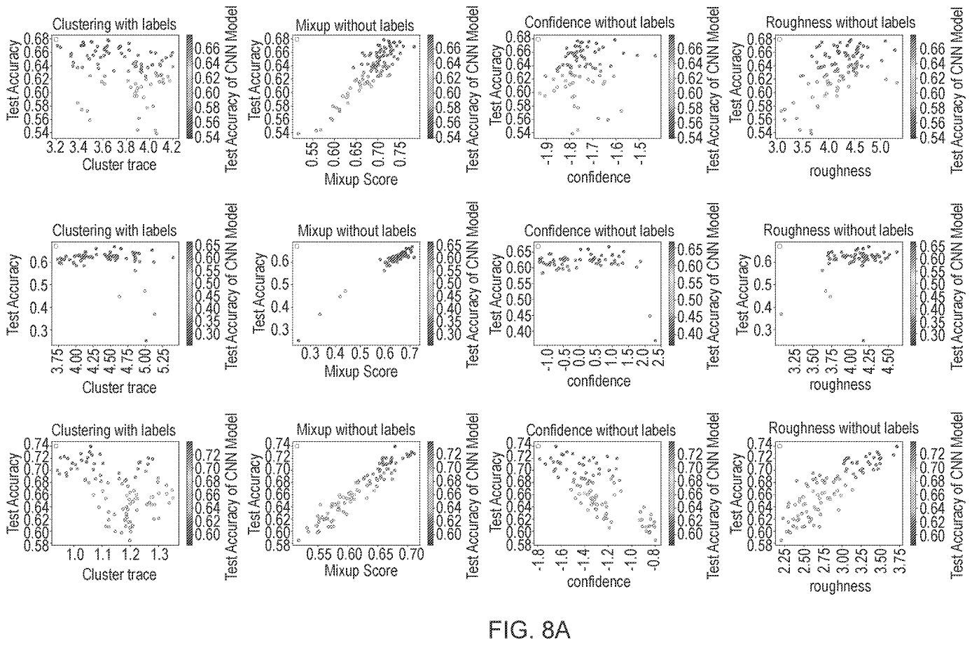

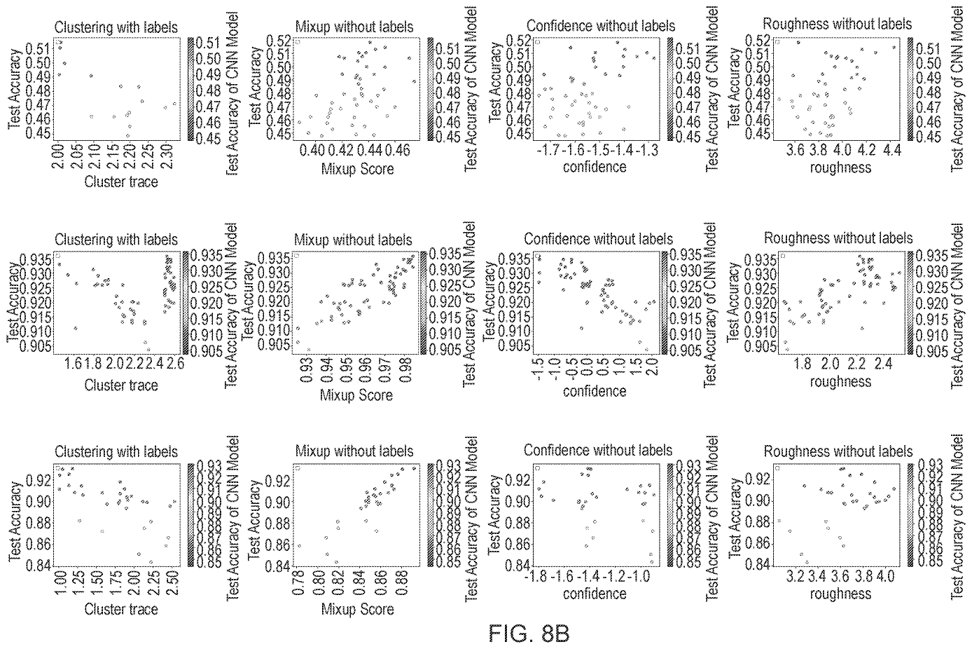

In FIG. 8, additional correlation plots are provided corresponding to each entry of Table 1. The correlation (either positive or negative) of points (models) depicts the performance of each cross-model generalization metric at a population-level, demonstrating the ability of label-free metrics to rank models even when they have 90%+ accuracy.

Sample-Level Correlation with and without Labels

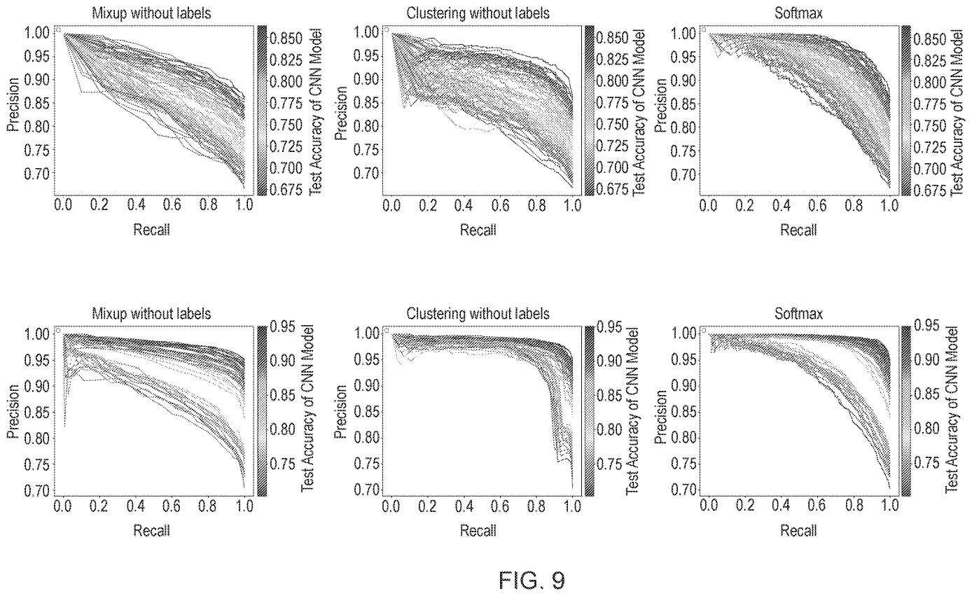

Next, the classification prediction performance of each sample-level metric was evaluated on test data. For comparison, the area under the curve (AUC) of the receiver-operator characteristic (ROC) was first calculated on all test data, demonstrating excellent consistency if 5-fold cross validation was performed using just 5% of the test set for calibration. Selecting the threshold corresponding to the optimal F1 score on the 5% subset, then the prediction accuracy was computed on the remaining 95%, along with the corresponding F1 score. As seen, the simple softmax criterion has the best performance. However, the theory-backed clustering and mixup approaches had excellent agreement and consistency with this metric. PR curves for a few select metrics are shown in FIG. 9, demonstrating that the clustering metric has superior precision even at 100% recall, indicating a high positive predictive value.

TABLE 2
Performance on a sample-by-sample basis on PGDL Tasks/Data

| | AUC | | | AUC | | | Prediction-Accuracy | | | F1 Score | | |
|---|---|---|---|---|---|---|---|---|---|---|---|---|
| | (Test Data) | | | (on 5% Test) | | | (on 95% Test) | | | (on 95% Test) | | |
| Task | Cluster | Mixup | Softmax | Cluster | Mixup | Softmax | Cluster | Mixup | Softmax | Cluster | Mixup | Softma |
| task1_v4 | 0.731 | 0.713 | 0.828 | 0.731 | 0.711 | 0.829 | 0.767 | 0.728 | 0.790 | 0.689 | 0.648 | 0.726 |
| task2_v1 | 0.878 | 0.772 | 0.882 | 0.880 | 0.774 | 0.882 | 0.892 | 0.804 | 0.862 | 0.831 | 0.711 | 0.795 |
| task4 | 0.710 | 0.684 | 0.765 | 0.711 | 0.684 | 0.764 | 0.701 | 0.660 | 0.708 | 0.656 | 0.619 | 0.678 |
| task5 | 0.688 | 0.695 | 0.749 | 0.689 | 0.695 | 0.748 | 0.669 | 0.661 | 0.691 | 0.637 | 0.630 | 0.670 |
| task6 | 0.840 | 0.680 | 0.869 | 0.840 | 0.681 | 0.869 | 0.803 | 0.665 | 0.808 | 0.759 | 0.616 | 0.772 |
| task7 | 0.719 | 0.669 | 0.777 | 0.718 | 0.670 | 0.772 | 0.661 | 0.595 | 0.669 | 0.664 | 0.615 | 0.700 |
| task8 | 0.816 | 0.794 | 0.914 | 0.813 | 0.793 | 0.913 | 0.854 | 0.835 | 0.888 | 0.763 | 0.735 | 0.814 |
| task9 | 0.811 | 0.742 | 0.908 | 0.806 | 0.741 | 0.907 | 0.857 | 0.786 | 0.877 | 0.771 | 0.678 | 0.802 |

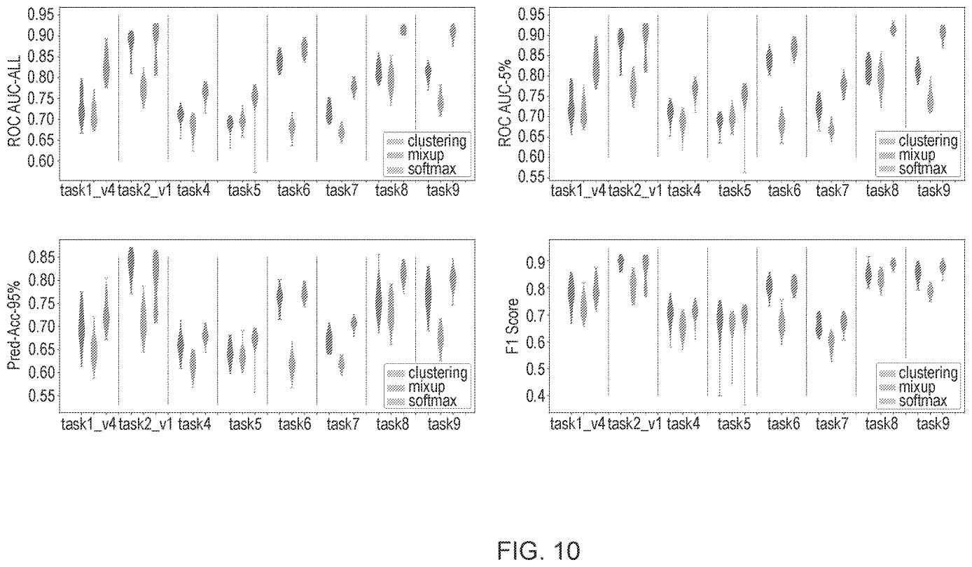

FIG. 10 shows violin plots depicting the distribution of AUC, accuracy, and F1-scores for CNN models corresponding to each PGDL task/dataset.

To further evaluate the utility of this approach, the sample-by-sample metrics were evaluated on adversarially-attacked test data. Specifically, a projected gradient descent (PGD) attack was conducted on a VGG-16 model trained on CIFAR-10, and the performance of different sample-level metrics in predicting correct and incorrect classifications was evaluated using the same evaluation strategy described herein. As seen in Table 4, clustering achieves the best performance across all measures (AUC, accuracy, F1-score), with performance similar to the performance on non-perturbed data (Tables 2 and 3). Although mixup achieves lower AUC and corresponding lower F1 score, the accuracy in correctness classification is higher than that of softmax. This is expected, as softmax relies on softmax values, demonstrating that the label-free metrics proposed in the main paper are advantageous in scenarios where the model is overly confident in the final prediction.

TABLE 4
Performance on a sample-by-sample basis on PGDL Task 1_v4 and PGDL Task 9
models using PGD-adversarially-attacked CIFAR-10 test-data, indicating mean +1σ stddev.

| | AUC (Test Data) | | | AUC (on 5% Test) | | | Prediction-Accuracy (95) | | | F1 Score (95% Test) | | |
|---|---|---|---|---|---|---|---|---|---|---|---|---|
| Task | Cluster | Mixup | Softmax | Cluster | Mixup | Softmax | Cluster | Mixup | Softmax | Cluster | Mixup | Softmax |
| task1_v4 | 0.782 ± | 0.471 ± | 0.676 ± | 0.782 ± | 0.474 ± | 0.678 ± | 0.712 ± | 0.556 ± | 0.65 ± | 0.611 ± | 0.244 ± | 0.505 ± |
| | 0.058 | 0.066 | 0.010 | 0.062 | 0.069 | 0.016 | 0.052 | 0.068 | 0.017 | 0.083 | 0.129 | 0.015 |
| task9 | 0.781 ± | 0.433 ± | 0.637 ± | 0.781 ± | 0.432 ± | 0.638 ± | 0.670 ± | 0.643 ± | 0.615 ± | 0.574 ± | 0.115 ± | 0.444 ± |
| | 0.023 | 0.066 | 0.014 | 0.029 | 0.069 | 0.022 | 0.021 | 0.037 | 0.018 | 0.036 | 0.047 | 0.018 |

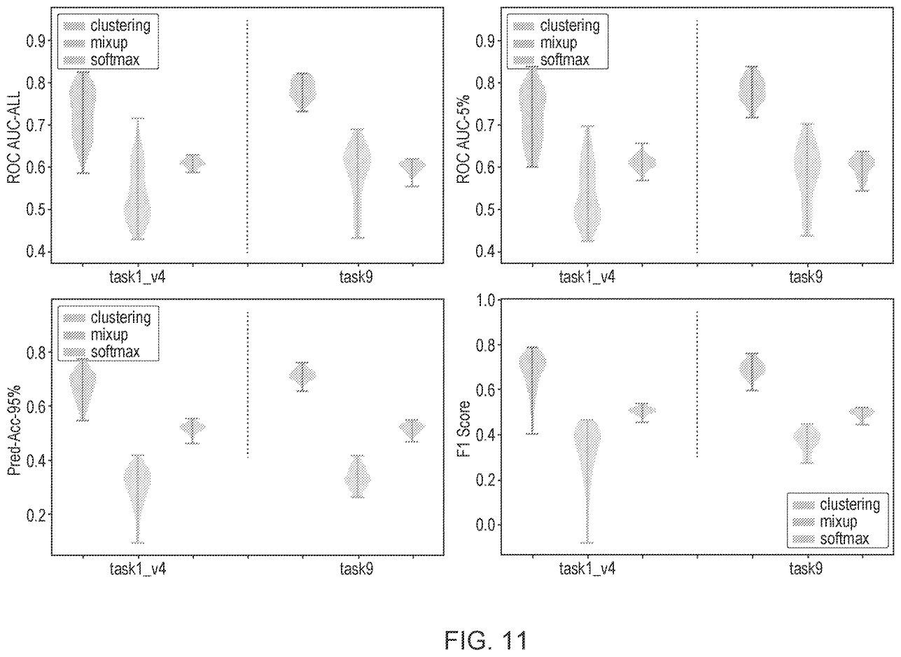

FIG. 11 shows violin plots depicting the distribution of AUC, accuracy, and F1-scores corresponding to PGDL Task 1_v4 and PGDL Task 9 models using PGD-adversarially-attacked CIFAR-10 test-data.

### Discission

Theory-inspired measures of network stability, feature separability, and consistency are surprisingly good at predicting the performance of machine-learning models such as CNNs (as demonstrated in the 2020 NeurIPS PGDL dataset), at both a population and sample level predictions. Although a calibrated softmax metric (i.e., the max of the output 1-hot encoded predicted vector) has somewhat superior performance on a sample level, it is noted that the calibrated softmax metric has poor performance on a population level across models using both training and testing data. Moreover, the softmax approach is tailored to 1-hot encoded representations of the classification problem, whereas the other methods are generally applicable to both scalar and vector predictions. More relevant is that theory-based metrics that agree closely with the softmax based prediction can be derived on a sample level, but still achieve good performance in comparing across models and architectures.

A qualitative analysis of the techniques and metrics described herein was also performed, especially for the sample level metrics which rely on the pixel-wise receptive fields to compute the likelihood of a layer's output given the input receptive fields. Specifically, receptive-field analysis was used combined with an approximate nearest-neighbor search of a given test sample's receptive field pixels in the space of receptive-field pixels of all the training data fitted on a KD tree. The KD tree was used to define the nearest-neighbor distance between the receptive field feature vectors owing to the high-dimensionality of these vectors and also to the success of KD trees in shape indexing of images. It was observed that the convolutional layers also perform a similar shape indexing by activating the receptive-field pixels corresponding to the semantic shape of the object in an image more than the background pixels. This manifests as activated pixels returning greater distances to the nearest neighbors from the training data as compared to the background pixels (shown in FIG. 3). This gives further evidence in favor of the metrics relying on the notion of distances and distances to clusters of samples in the intermediate feature space. Advantageously, it is hopeful that the techniques and metrics described herein address artificial intelligence safety concerns, in healthcare, operations, and transportation.

### Additional Considerations

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The ensuing description provides preferred exemplary embodiments only, and is not intended to limit the scope, applicability or configuration of the disclosure. Rather, the ensuing description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the following description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-implemented method comprising:
obtaining testing data without ground truth labels;
inputting the testing data into a machine-learning model;
generating, using the machine-learning model comprising model parameters learned for a particular task, a prediction associated with the task based on the test data;
obtaining one or more metrics for generalization of the machine-learning model on the test data, where the obtaining comprises: (i) computing metrics using intermediate feature representations extracted from the nodes of the computational graph or abstract syntax tree (AST) of the machine learning model, (ii) computing metrics using the output prediction in conjunction with the input data or intermediate features, (iii) computing metrics using the model weights and architectures and its interactions with the input data, intermediate features, or output predictions, or (iv) any combination of (i-iii); and
outputting a prediction of model generalization for the machine learning model at the population-level based on the one or more metrics.

2. A computer-implemented method comprising:
obtaining testing data without ground truth labels;
inputting the testing data into a machine-learning model;
generating, using the machine-learning model comprising model parameters learned for a particular task, a prediction associated with the task based on the test data;
obtaining one or more metrics for generalization of the machine-learning model on the test data, wherein the obtaining comprises executing various neural trace analysis algorithms that capture, summarize, or derive intelligence from intermediate feature representations at nodes of the machine-learning model's computational graph or abstract syntax tree (AST) during program execution in response to input data, including:
(i) computing a clustering metric based on clustering of the intermediate feature representations within input samples of the testing data, wherein the clustering is calculated based on a subset of samples obtained from training data with ground truth labels;
(ii) computing a modified Mixup metric based on convex combinations of each of the input samples from the testing data and a subset of samples obtained from the training data with ground truth labels corresponding to the prediction for each of the input samples;
(iii) computing a confidence metric based on clustering of the intermediate feature representations within the input samples of the testing data, wherein the clustering is calculated based on the input samples from the testing data;
(iv) computing a roughness metric using dimensionality-reduction of the intermediate features to define a smoothness criteria for the training data and the testing data; or
(v) any combination of (i)-(iv); and
outputting a prediction of model generalization for the machine learning model at a level of the testing data based on the one or more metrics.

3. The computer-implemented method of claim 2, wherein the computing the clustering metric comprises:
extracting the intermediate feature representations for each input sample in the testing data;
performing, using the subset of samples and principal component analysis, the dimensionality-reduction of the intermediate features to predetermined dimensions at each layer of the machine-learning model, wherein the ground truth labels of the training data indicate membership to one or more classes;
computing the clustering for the testing data based on a partition of the subset of samples, wherein the membership is used as the partition to compute and average the clustering metric to measure the clustering over each layer of the machine-learning model;
fitting mixture models or kernel density estimators to the intermediate feature representations corresponding to the samples from the subset of samples in the partition, wherein the fitting comprises computing a secondary partition at each layer on the input samples in the testing data based on the clustering computed for the testing data to obtain parameters for the mixture models; and
computing the clustering metric based on the measure of the clustering over each layer of the machine-learning model and the mixture models.

4. The computer-implemented method of claim 2, wherein the modified Mixup metric comprises:
computing an agreement in classification between each of the input samples from the testing data and the subset of the training data corresponding to the prediction for each of the input samples;
when the agreement is indicative that the prediction is incorrect, the input sample is mixed with a subset of the input samples from the testing data that correspond to the incorrect prediction; and
when the agreement is indicative that the prediction is correct, using the agreement as the modified Mixup metric.

5. The computer-implemented method of claim 2, wherein the computing the confidence metric comprises:
extracting the intermediate feature representations for each input sample in the testing data;
computing a partition of the subset of samples obtained from training data by k-means or similar clustering of an output domain of each layer of the machine-learning model, wherein the ground truth labels of the training data indicate membership to one or more classes;
computing the clustering for the testing data based on a partition of the subset of samples, wherein the membership is used as the partition to compute and average the clustering metric to measure the clustering over each layer of the machine-learning model;
fitting mixture models or kernel density estimators to the intermediate feature representations corresponding to the samples from the subset of samples in the partition, wherein the fitting comprises computing a secondary partition at each layer on the input samples in the testing data based on the clustering computed for the testing data to obtain parameters for the mixture models; and
computing the confidence metric based on the measure of the clustering over each layer of the machine-learning model and the mixture models.

6. The computer-implemented method of claim 2, wherein the computing the roughness metric comprises:
extracting the intermediate feature representations for each input sample in the testing data;
computing a partition of the subset of samples obtained from training data by k-means or similar clustering of an output domain of each layer of the machine-learning model, wherein the ground truth labels of the training data indicate membership to one or more classes;
computing the clustering for the testing data based on a partition of the subset of samples, wherein the membership is used as the partition to compute and average the clustering metric to measure the clustering over each layer of the machine-learning model; and
computing the roughness metric based on the measure of the clustering over each layer of the machine-learning model.

7. The computer-implemented method of claim 2, further comprising predicting the model generalization for the machine learning model at the level of the testing data based on the one or more metrics.

8. A computer-implemented method comprising:
obtaining a sample query without ground truth labels;
inputting the sample query into a machine-learning model;
generating, using the machine-learning model comprising model parameters learned for a particular task, a prediction associated with the task based on the sample query;
obtaining one or more metrics for generalization of the machine-learning model on the sample query, wherein the obtaining comprises: (i) computing metrics using intermediate feature representations extracted from the nodes of the computational graph or abstract syntax tree (AST) of the machine learning model, (ii) computing metrics using the output prediction in conjunction with the input data or intermediate features, (iii) computing metrics using the model weights and architectures and its interactions with the input data, intermediate features, or output predictions, or (iv) any combination of (i-iii); and
outputting a prediction of model generalization for the machine learning model at a level of the sample query based on the one or more metrics.

9. A computer-implemented method comprising:
obtaining a sample query without ground truth labels;
inputting the sample query into a machine-learning model;
generating, using the machine-learning model comprising model parameters learned for a particular task, a prediction associated with the task based on the sample query;
obtaining one or more metrics for generalization of the machine-learning model on the sample query, wherein the obtaining comprises executing various neural trace analysis algorithms that capture, summarize, or derive intelligence from intermediate feature representations at nodes of the machine-learning model's computational graph or abstract syntax tree (AST) during program execution in response to input data, including:
(i) computing a clustering metric based on clustering of the intermediate feature representations within the sample query, wherein the clustering is calculated based on a subset of samples obtained from training data with ground truth labels;
(ii) computing a modified Mixup metric based on convex combinations of the sample query and a subset of samples obtained from the training data with ground truth labels corresponding to the prediction for the sample query;
(iii) computing a confidence metric based on clustering of the intermediate feature representations within the sample query; or
(iv) any combination of (i)-(iii); and
outputting a prediction of model generalization for the machine learning model at a level of the sample query based on the one or more metrics.

10. The computer-implemented method of claim 9, wherein the computing the clustering metric comprises:
extracting the intermediate feature representations for the sample query;
performing, using the subset of samples and principal component analysis, the dimensionality-reduction of the intermediate features to predetermined dimensions at each layer of the machine-learning model, wherein the outputs machine-learning model's prediction of the sample query data indicate membership to one or more classes;
computing the clustering for the sample query based on a partition of the subset of samples, wherein the membership is used as the partition to compute and average the clustering metric to measure the clustering over each layer of the machine-learning model;
fitting mixture models or kernel density estimators to the intermediate feature representations corresponding to the samples from the subset of samples in the partition, wherein the fitting comprises computing a secondary partition at each layer on the sample query based on the clustering computed for the sample query to obtain parameters for the mixture models; and
computing the clustering metric based on the measure of the clustering over each layer of the machine-learning model and the mixture models.

11. The computer-implemented method of claim 9, wherein the modified Mixup metric comprises:
computing an agreement in classification between the sample query and the subset of the training data corresponding to the prediction for the sample query;
when the agreement is indicative that the prediction is incorrect, the sample query is mixed with a subset of the input samples from the training data that correspond to the incorrect prediction; and
when the agreement is indicative that the prediction is correct, using the agreement as the modified Mixup metric.

12. The computer-implemented method of claim 9, wherein the computing the confidence metric comprises:
extracting the intermediate feature representations for the sample query;
computing a partition of the subset of samples obtained from training data by k-means or similar clustering of an output domain of each layer of the machine-learning model,
computing the clustering for the sample query based on a partition of the subset of samples, wherein the membership is used as the partition to compute and average the clustering metric to measure the clustering over each layer of the machine-learning model;
fitting mixture models or kernel density estimators to the intermediate feature representations corresponding to the samples from the subset of samples in the partition, wherein the fitting comprises computing a secondary partition at each layer on the sample query based on the clustering computed for the sample query to obtain parameters for the mixture models; and
computing the confidence metric based on the measure of the clustering over each layer of the machine-learning model and the mixture models.

13. The computer-implemented method of claim 9, further comprising predicting the model generalization for the machine learning model at the level of the sample query based on the one or more metrics.

14. A system comprising:
one or more processors; and
a memory coupled to the one or more processors, the memory storing a plurality of instructions executable by the one or more processors, the plurality of instructions comprising instructions that when executed by the one or more processors cause the one or more processors to perform operations comprising:
obtaining testing data without ground truth labels;
inputting the testing data into a machine-learning model;
generating, using the machine-learning model comprising model parameters learned for a particular task, a prediction associated with the task based on the test data;
obtaining one or more metrics for generalization of the machine-learning model on the test data, where the obtaining comprises: (i) computing metrics using intermediate feature representations extracted from the nodes of the computational graph or abstract syntax tree (AST) of the machine learning model, (ii) computing metrics using the output prediction in conjunction with the input data or intermediate features, (iii) computing metrics using the model weights and architectures and its interactions with the input data, intermediate features, or output predictions, or (iv) any combination of (i-iii); and
outputting a prediction of model generalization for the machine learning model at the population-level based on the one or more metrics.

15. A system comprising:
one or more processors; and
a memory coupled to the one or more processors, the memory storing a plurality of instructions executable by the one or more processors, the plurality of instructions comprising instructions that when executed by the one or more processors cause the one or more processors to perform operations comprising:
obtaining testing data without ground truth labels;
inputting the testing data into a machine-learning model;
generating, using the machine-learning model comprising model parameters learned for a particular task, a prediction associated with the task based on the test data;
obtaining one or more metrics for generalization of the machine-learning model on the test data, wherein the obtaining comprises of various neural trace analysis algorithms that capture, summarize, or derive intelligence from intermediate feature representations at nodes of the machine-learning model's computational graph or abstract syntax tree (AST) during program execution in response to input data, including:
(i) computing a clustering metric based on clustering of the intermediate feature representations within input samples of the testing data, wherein the clustering is calculated based on a subset of samples obtained from training data with ground truth labels;
(ii) computing a modified Mixup metric based on convex combinations of each of the input samples from the testing data and a subset of samples obtained from the training data with ground truth labels corresponding to the prediction for each of the input samples;
(iii) computing a confidence metric based on clustering of the intermediate feature representations within the input samples of the testing data, wherein the clustering is calculated based on the input samples from the testing data;
(iv) computing a roughness metric using dimensionality-reduction of the intermediate features to define a smoothness criteria for the training data and the testing data; or
(v) any combination of (i)-(iv); and
outputting a prediction of model generalization for the machine learning model at a level of the testing data based on the one or more metrics.

16. The system of claim 15, wherein the computing the clustering metric comprises:
extracting the intermediate feature representations for each input sample in the testing data;
performing, using the subset of samples and principal component analysis, the dimensionality-reduction of the intermediate features to predetermined dimensions at each layer of the machine-learning model, wherein the ground truth labels of the training data indicate membership to one or more classes;
computing the clustering for the testing data based on a partition of the subset of samples, wherein the membership is used as the partition to compute and average the clustering metric to measure the clustering over each layer of the machine-learning model;
fitting mixture models or kernel density estimators to the intermediate feature representations corresponding to the samples from the subset of samples in the partition, wherein the fitting comprises computing a secondary partition at each layer on the input samples in the testing data based on the clustering computed for the testing data to obtain parameters for the mixture models; and
computing the clustering metric based on the measure of the clustering over each layer of the machine-learning model and the mixture models.

17. The system of claim 15, wherein the modified Mixup metric comprises:
computing an agreement in classification between each of the input samples from the testing data and the subset of the training data corresponding to the prediction for each of the input samples;
when the agreement is indicative that the prediction is incorrect, the input sample is mixed with a subset of the input samples from the testing data that correspond to the incorrect prediction; and
when the agreement is indicative that the prediction is correct, using the agreement as the modified Mixup metric.

18. The system of claim 15, wherein the computing the confidence metric comprises:
extracting the intermediate feature representations for each input sample in the testing data;
computing a partition of the subset of samples obtained from training data by k-means or similar clustering of an output domain of each layer of the machine-learning model, wherein the ground truth labels of the training data indicate membership to one or more classes;
computing the clustering for the testing data based on a partition of the subset of samples, wherein the membership is used as the partition to compute and average the clustering metric to measure the clustering over each layer of the machine-learning model;
fitting mixture models or kernel density estimators to the intermediate feature representations corresponding to the samples from the subset of samples in the partition, wherein the fitting comprises computing a secondary partition at each layer on the input samples in the testing data based on the clustering computed for the testing data to obtain parameters for the mixture models; and
computing the confidence metric based on the measure of the clustering over each layer of the machine-learning model and the mixture models.

19. The system of claim 15, wherein the computing the roughness metric comprises:
extracting the intermediate feature representations for each input sample in the testing data;
computing a partition of the subset of samples obtained from training data by k-means or similar clustering of an output domain of each layer of the machine-learning model, wherein the ground truth labels of the training data indicate membership to one or more classes;
computing the clustering for the testing data based on a partition of the subset of samples, wherein the membership is used as the partition to compute and average the clustering metric to measure the clustering over each layer of the machine-learning model; and
computing the roughness metric based on the measure of the clustering over each layer of the machine-learning model.

20. The system of claim 15, wherein the operations further comprise predicting the model generalization for the machine learning model at the level of the testing data based on the one or more metrics.

21. A system comprising:
one or more processors; and
a memory coupled to the one or more processors, the memory storing a plurality of instructions executable by the one or more processors, the plurality of instructions comprising instructions that when executed by the one or more processors cause the one or more processors to perform operations comprising:
obtaining a sample query without ground truth labels; inputting the sample query into a machine-learning model;
generating, using the machine-learning model comprising model parameters learned for a particular task, a prediction associated with the task based on the sample query;
obtaining one or more metrics for generalization of the machine-learning model on the sample query, wherein the obtaining comprises: (i) computing metrics using intermediate feature representations extracted from the nodes of the computational graph or abstract syntax tree (AST) of the machine learning model, (ii) computing metrics using the output prediction in conjunction with the input data or intermediate features, (iii) computing metrics using the model weights and architectures and its interactions with the input data, intermediate features, or output predictions, or (iv) any combination of (i-iii); and
outputting a prediction of model generalization for the machine learning model at a level of the sample query based on the one or more metrics.

22. A system comprising:
one or more processors; and
a memory coupled to the one or more processors, the memory storing a plurality of instructions executable by the one or more processors, the plurality of instructions comprising instructions that when executed by the one or more processors cause the one or more processors to perform operations comprising:
obtaining a sample query without ground truth labels;
inputting the sample query into a machine-learning model;
generating, using the machine-learning model comprising model parameters learned for a particular task, a prediction associated with the task based on the sample query;
obtaining one or more metrics for generalization of the machine-learning model on the sample query, wherein the obtaining comprises of various neural trace analysis algorithms that capture, summarize, or derive intelligence from intermediate feature representations at nodes of the machine-learning model's computational graph or abstract syntax tree (AST) during program execution in response to input data, including:
(i) computing a clustering metric based on clustering of the intermediate feature representations within the sample query, wherein the clustering is calculated based on a subset of samples obtained from training data with ground truth labels;
(ii) computing a modified Mixup metric based on convex combinations of the sample query and a subset of samples obtained from the training data with ground truth labels corresponding to the prediction for the sample query;
(iii) computing a confidence metric based on clustering of the intermediate feature representations within the sample query; or
(iv) any combination of (i)-(iii); and
outputting a prediction of model generalization for the machine learning model at a level of the sample query based on the one or more metrics.

23. The system of claim 22, wherein the computing the clustering metric comprises:
extracting the intermediate feature representations for the sample query;
performing, using the subset of samples and principal component analysis, the dimensionality-reduction of the intermediate features to predetermined dimensions at each layer of the machine-learning model, wherein the outputs machine-learning model's prediction of the sample query data indicate membership to one or more classes;
computing the clustering for the sample query based on a partition of the subset of samples, wherein the membership is used as the partition to compute and average the clustering metric to measure the clustering over each layer of the machine-learning model;
fitting mixture models or kernel density estimators to the intermediate feature representations corresponding to the samples from the subset of samples in the partition, wherein the fitting comprises computing a secondary partition at each layer on the sample query based on the clustering computed for the sample query to obtain parameters for the mixture models; and
computing the clustering metric based on the measure of the clustering over each layer of the machine-learning model and the mixture models.

24. The system of claim 22, wherein the modified Mixup metric comprises:
computing an agreement in classification between the sample query and the subset of the training data corresponding to the prediction for the sample query;
when the agreement is indicative that the prediction is incorrect, the sample query is mixed with a subset of the input samples from the training data that correspond to the incorrect prediction; and
when the agreement is indicative that the prediction is correct, using the agreement as the modified Mixup metric.

25. The system of claim 22, wherein the computing the confidence metric comprises:
extracting the intermediate feature representations for the sample query;
computing a partition of the subset of samples obtained from training data by k-means or similar clustering of an output domain of each layer of the machine-learning model,
computing the clustering for the sample query based on a partition of the subset of samples, wherein the membership is used as the partition to compute and average the clustering metric to measure the clustering over each layer of the machine-learning model;
fitting mixture models or kernel density estimators to the intermediate feature representations corresponding to the samples from the subset of samples in the partition, wherein the fitting comprises computing a secondary partition at each layer on the sample query based on the clustering computed for the sample query to obtain parameters for the mixture models; and
computing the confidence metric based on the measure of the clustering over each layer of the machine-learning model and the mixture models.

26. The system of claim 22, wherein the operations further comprise predicting the model generalization for the machine learning model at the level of the sample query based on the one or more metrics.

27. A non-transitory computer-readable memory storing a plurality of instructions executable by one or more processors, the plurality of instructions comprising instructions that when executed by the one or more processors cause the one or more processors to perform operations comprising:
obtaining testing data without ground truth labels;
inputting the testing data into a machine-learning model;
generating, using the machine-learning model comprising model parameters learned for a particular task, a prediction associated with the task based on the test data;
obtaining one or more metrics for generalization of the machine-learning model on the test data, where the obtaining comprises: (i) computing metrics using intermediate feature representations extracted from the nodes of the computational graph or abstract syntax tree (AST) of the machine learning model, (ii) computing metrics using the output prediction in conjunction with the input data or intermediate features, (iii) computing metrics using the model weights and architectures and its interactions with the input data, intermediate features, or output predictions, or (iv) any combination of (i-iii); and
outputting a prediction of model generalization for the machine learning model at the population-level based on the one or more metrics.

28. A non-transitory computer-readable memory storing a plurality of instructions executable by one or more processors, the plurality of instructions comprising instructions that when executed by the one or more processors cause the one or more processors to perform operations comprising:
obtaining testing data without ground truth labels;
inputting the testing data into a machine-learning model;
generating, using the machine-learning model comprising model parameters learned for a particular task, a prediction associated with the task based on the test data;
obtaining one or more metrics for generalization of the machine-learning model on the test data, wherein the obtaining comprises of various neural trace analysis algorithms that capture, summarize, or derive intelligence from intermediate feature representations at nodes of the machine-learning model's computational graph or abstract syntax tree (AST) during program execution in response to input data, including:
(i) computing a clustering metric based on clustering of the intermediate feature representations within input samples of the testing data, wherein the clustering is calculated based on a subset of samples obtained from training data with ground truth labels;
(ii) computing a modified Mixup metric based on convex combinations of each of the input samples from the testing data and a subset of samples obtained from the training data with ground truth labels corresponding to the prediction for each of the input samples;
(iii) computing a confidence metric based on clustering of the intermediate feature representations within the input samples of the testing data, wherein the clustering is calculated based on the input samples from the testing data;
(iv) computing a roughness metric using dimensionality-reduction of the intermediate features to define a smoothness criteria for the training data and the testing data; or
(v) any combination of (i)-(iv); and
outputting a prediction of model generalization for the machine learning model at a level of the testing data based on the one or more metrics.

29. The non-transitory computer-readable memory of claim 28, wherein the computing the clustering metric comprises:
extracting the intermediate feature representations for each input sample in the testing data;
performing, using the subset of samples and principal component analysis, the dimensionality-reduction of the intermediate features to predetermined dimensions at each layer of the machine-learning model, wherein the ground truth labels of the training data indicate membership to one or more classes;
computing the clustering for the testing data based on a partition of the subset of samples, wherein the membership is used as the partition to compute and average the clustering metric to measure the clustering over each layer of the machine-learning model;
fitting mixture models or kernel density estimators to the intermediate feature representations corresponding to the samples from the subset of samples in the partition, wherein the fitting comprises computing a secondary partition at each layer on the input samples in the testing data based on the clustering computed for the testing data to obtain parameters for the mixture models; and
computing the clustering metric based on the measure of the clustering over each layer of the machine-learning model and the mixture models.

30. The non-transitory computer-readable memory of claim 28, wherein the modified Mixup metric comprises:
computing an agreement in classification between each of the input samples from the testing data and the subset of the training data corresponding to the prediction for each of the input samples;
when the agreement is indicative that the prediction is incorrect, the input sample is mixed with a subset of the input samples from the testing data that correspond to the incorrect prediction; and
when the agreement is indicative that the prediction is correct, using the agreement as the modified Mixup metric.

31. The non-transitory computer-readable memory of claim 28, wherein the computing the confidence metric comprises:
extracting the intermediate feature representations for each input sample in the testing data;
computing a partition of the subset of samples obtained from training data by k-means or similar clustering of an output domain of each layer of the machine-learning model, wherein the ground truth labels of the training data indicate membership to one or more classes;
computing the clustering for the testing data based on a partition of the subset of samples, wherein the membership is used as the partition to compute and average the clustering metric to measure the clustering over each layer of the machine-learning model;
fitting mixture models or kernel density estimators to the intermediate feature representations corresponding to the samples from the subset of samples in the partition, wherein the fitting comprises computing a secondary partition at each layer on the input samples in the testing data based on the clustering computed for the testing data to obtain parameters for the mixture models; and
computing the confidence metric based on the measure of the clustering over each layer of the machine-learning model and the mixture models.

32. The non-transitory computer-readable memory of claim 28, wherein the computing the roughness metric comprises:
extracting the intermediate feature representations for each input sample in the testing data;
computing a partition of the subset of samples obtained from training data by k-means or similar clustering of an output domain of each layer of the machine-learning model, wherein the ground truth labels of the training data indicate membership to one or more classes;
computing the clustering for the testing data based on a partition of the subset of samples, wherein the membership is used as the partition to compute and average the clustering metric to measure the clustering over each layer of the machine-learning model; and
computing the roughness metric based on the measure of the clustering over each layer of the machine-learning model.

33. The non-transitory computer-readable memory of claim 28, wherein the operations further comprise predicting the model generalization for the machine learning model at the level of the testing data based on the one or more metrics.

34. A non-transitory computer-readable memory comprising:
one or more processors; and
a memory coupled to the one or more processors, the memory storing a plurality of instructions executable by the one or more processors, the plurality of instructions comprising instructions that when executed by the one or more processors cause the one or more processors to perform operations comprising:
obtaining a sample query without ground truth labels;
inputting the sample query into a machine-learning model;
generating, using the machine-learning model comprising model parameters learned for a particular task, a prediction associated with the task based on the sample query;
obtaining one or more metrics for generalization of the machine-learning model on the sample query, wherein the obtaining comprises: (i) computing metrics using intermediate feature representations extracted from the nodes of the computational graph or abstract syntax tree (AST) of the machine learning model, (ii) computing metrics using the output prediction in conjunction with the input data or intermediate features, (iii) computing metrics using the model weights and architectures and its interactions with the input data, intermediate features, or output predictions, or (iv) any combination of (i-iii); and
outputting a prediction of model generalization for the machine learning model at a level of the sample query based on the one or more metrics.

35. A non-transitory computer-readable memory comprising:
one or more processors; and
a memory coupled to the one or more processors, the memory storing a plurality of instructions executable by the one or more processors, the plurality of instructions comprising instructions that when executed by the one or more processors cause the one or more processors to perform operations comprising:
obtaining a sample query without ground truth labels;
inputting the sample query into a machine-learning model;
generating, using the machine-learning model comprising model parameters learned for a particular task, a prediction associated with the task based on the sample query;
obtaining one or more metrics for generalization of the machine-learning model on the sample query, wherein the obtaining comprises of various neural trace analysis algorithms that capture, summarize, or derive intelligence from intermediate feature representations at nodes of the machine-learning model's computational graph or abstract syntax tree (AST) during program execution in response to input data, including:
(i) computing a clustering metric based on clustering of the intermediate feature representations within the sample query, wherein the clustering is calculated based on a subset of samples obtained from training data with ground truth labels;
(ii) computing a modified Mixup metric based on convex combinations of the sample query and a subset of samples obtained from the training data with ground truth labels corresponding to the prediction for the sample query;
(iii) computing a confidence metric based on clustering of the intermediate feature representations within the sample query; or
(iv) any combination of (i)-(iii); and
outputting a prediction of model generalization for the machine learning model at a level of the sample query based on the one or more metrics.

36. The non-transitory computer-readable memory of claim 35, wherein the computing the clustering metric comprises:
extracting the intermediate feature representations for the sample query;
performing, using the subset of samples and principal component analysis, the dimensionality-reduction of the intermediate features to predetermined dimensions at each layer of the machine-learning model, wherein the outputs machine-learning model's prediction of the sample query data indicate membership to one or more classes;
computing the clustering for the sample query based on a partition of the subset of samples, wherein the membership is used as the partition to compute and average the clustering metric to measure the clustering over each layer of the machine-learning model;
fitting mixture models or kernel density estimators to the intermediate feature representations corresponding to the samples from the subset of samples in the partition, wherein the fitting comprises computing a secondary partition at each layer on the sample query based on the clustering computed for the sample query to obtain parameters for the mixture models; and
computing the clustering metric based on the measure of the clustering over each layer of the machine-learning model and the mixture models.

37. The non-transitory computer-readable memory of claim 35, wherein the modified Mixup metric comprises:
computing an agreement in classification between the sample query and the subset of the training data corresponding to the prediction for the sample query;
when the agreement is indicative that the prediction is incorrect, the sample query is mixed with a subset of the input samples from the training data that correspond to the incorrect prediction; and
when the agreement is indicative that the prediction is correct, using the agreement as the modified Mixup metric.

38. The non-transitory computer-readable memory of claim 35, wherein the computing the confidence metric comprises:
extracting the intermediate feature representations for the sample query;
computing a partition of the subset of samples obtained from training data by k-means or similar clustering of an output domain of each layer of the machine-learning model,
computing the clustering for the sample query based on a partition of the subset of samples, wherein the membership is used as the partition to compute and average the clustering metric to measure the clustering over each layer of the machine-learning model;
fitting mixture models or kernel density estimators to the intermediate feature representations corresponding to the samples from the subset of samples in the partition, wherein the fitting comprises computing a secondary partition at each layer on the sample query based on the clustering computed for the sample query to obtain parameters for the mixture models; and
computing the confidence metric based on the measure of the clustering over each layer of the machine-learning model and the mixture models.

39. The non-transitory computer-readable memory of claim 35, wherein the operations further comprise predicting the model generalization for the machine learning model at the level of the sample query based on the one or more metrics.
